(19) United States
(12) Patent Application Publication
(10) Pub. No.: US 2018/0259903 A1
(43) Pub. Date: Sep. 13, 2018

(54) HOLOGRAPHIC-LIKE IMAGING DEVICES AND SYSTEMS

(71) Applicant: Paul Patrick Paige, Las Vegas, NV (US)

(72) Inventor: Paul Patrick Paige, Las Vegas, NV (US)

(21) Appl. No.: 15/912,251

(22) Filed: Mar. 5, 2018

Related U.S. Application Data
(60) Provisional application No. 62/467,474, filed on Mar. 6, 2017.

(51) Int. Cl. G03H 1/04; G02B 27/09; G03H 1/02

(52) U.S. Cl. CPC G03H 1/0402; G02B 27/0977; G02B 27/0955; G03H 2001/0436; G03H 2001/026; G03H 2223/23; G03H 1/024

(57) ABSTRACT

Imaging devices or systems for providing a perception of a holographic-like or 3-dimensional image from a 2-dimensional image is provided to include: a lens having a lens axis and operating to receive a light reflecting from an object in a first direction and reflect the received light in a second direction, the object located on or around the lens axis; and a recording device arranged to receive the reflected light from the lens and records an image of an object, the image of the object having distortion information that provide a holographic-like effects.

### CROSS-REFERENCE TO RELATED APPLICATION(S)

This patent document claims priorities to and benefits of U.S. Provisional Patent Application No. 62/464,474 entitled “HOLOGRAPHIC-LIKE INVENTION” filed on Mar. 6, 2017. The entire content of the aforementioned patent application is incorporated by reference as part of the disclosure of this patent document.

### TECHNICAL FIELD

This patent document relates to imaging devices, systems and techniques for providing certain visual effects such as three-dimensional (3D) or holographic effects.

### BACKGROUND

Imaging devices or systems based on one or more optical lenses can be used to produce optical images with desired visual effects. For example, some imaging devices or system can provide a viewer with a perception of an image beyond a 2-dimensional rendition of the image to achieve a more realistic view of an object represented by the perceived image for entertaining the viewer or other applications. Examples of certain desired visual effects include a holographic or 3D effects.

### SUMMARY

The disclosed technology in this patent document provides an imaging system that provide virtual reality effects including 3D or holographic effects.

In one aspect, an imaging apparatus providing a holographic-like image is provided to include: a lens having a lens axis and operating to receive light rays from an object and change directions of the light rays passing through the lens, the object located on or around the lens axis; and a recording device arranged to receive the light rays from the lens and records an image of an object, the image of the object having distortion information that provide holographic effects.

In some implementations, the lens operates as a Fresnel lens magnifier. In some implementations, the lens includes a disc lens or a cylinder lens. In some implementations, the image of the object includes a single flat, two-dimensional image. In some implementations, the recording device includes a camera, a flat screen display, or an image projector. In some implementations, the recording device is centered on the lens axis.

In another aspect, an imaging apparatus providing a holographic-like image is provided to include a first lens having a lens axis and operating to reflect a light originating from an object; a recording device centered on the lens axis and operates to receive the reflected light from the first lens and records an image of the object; and a second lens arranged to receive the image from the recording device through the first lens and operates to provide a holographic-like perception to a viewer.

In some implementations, the second lens is arranged to form a bucket shape with the first lens such that the second lens has an end near which the first lens is centered. In some implementations, the first lens and the second lens are fully enclosed. In some implementations, at least one of the first lens or the second lens has a shape that forms a portion of an enclosure. In some implementations, the first lens is rotatable in a plane where the first lens is arranged. In some implementations, the second lens is curved. In some implementations, the first lens is movable between two planes that are orthogonal to each other such that the first lens is located parallel to second lens along the lens axis. In some implementations, the first lens includes a disc lens and the second lens includes at least one of a cylinder lens, a cube lens, or a cone lens. In some implementations, the first lens and the second lens are combined together to provide a single unit having optical properties of the first lens and the second lens. In some implementations, the first lens and the second lens include portions of a Fresnel lens.

In another aspect, an imaging apparatus viewing a holographic-like image is provided to include an object; an image holder positioned to face the object and holding an image of the object having intentionally intended distortions, wherein the image is obtained by passing lights reflecting from the object through a lens having a lens center in a direction radially outward from the lens center and at an angle with regard to the lens; and a stereoscope arranged to be movable with regard to the image holder and operates to allow a viewer to view the object through the image holder.

In some implementations, the image holder holds an additional image that is different from or identical to the image. In some implementations, the image holder is positioned to be movable with respect to the stereoscope, the movement of the image holder changing viewpoints of the object. In some implementations, the image holder is flat or curved.

In another aspect, a method for rendering an image to a viewer with a holographic like or 3-dimensional perception is provided to comprise: recording an image from light rays received from a curved recording lens that includes a cylindrical shape at a location below the curved recording lens at or near a geometrical axis of the cylindrical shape to receive light rays from one or more objects or a scene located outside the curved recording lens; and displaying the recorded image at a surface that is located below a curved image-rendering lens that is similar or identical to the curved recording lens used in recording the image to direct light from the displayed image to inner space of the curved image-rendering lens and to be optically modified to produce emerging light rays to be perceived by one or more viewers looking at the curved image-rendering lens as being from one or more objects or a scene located in or outside the inner space within the cylindrical shape of the curved image-rendering lens.

In some implementations, the method further comprises placing a second recording lens between the curved recording lens and the location for recording the image to further optically modify the light rays from the curved recording lens in recording the image; and placing a second image-rendering lens located between the curved image-rendering lens and the surface displaying the recorded image to optically modify the light rays before reaching the curved image-rendering lens for viewing.

In another aspect, an imaging display device for rendering an image to a viewer with a holographic like or 3-dimensional perception is provided to comprise: a curved image-rendering lens that includes a cylindrical shape to support a curved side surface and an inner space within the curved side surface; and an image displaying device placed below the curved image-rendering lens to display still or moving images that are recorded via a curved recording lens that is similar or identical to the curved image-rendering lens to direct light from the displayed image to inner space of the curved image-rendering lens and to be optically modified to produce emerging light rays outside the cylindrical shape to be viewed by a viewer.

In some implementations, the device further includes a second recording lens between the curved recording lens and the location for recording the image to further optically modify the light rays from the curved recording lens in recording the image; and a second image-rendering lens located between the curved image-rendering lens and the image displaying device displaying the recorded image to optically modify the light rays before reaching the curved image-rendering lens for viewing.

### BRIEF DESCRIPTION OF THE DRAWINGS

FIGS. 1-3 show a perspective view, top view and side view of an exemplary lens included in an exemplary imaging system based on one implementation of the disclosed technology.

FIGS. 4-7 show views indicating various light rays passing before and through an exemplary lens of an exemplary imaging system.

FIGS. 8-12 show various views of an exemplary imaging system including a recording device positioned relative to an exemplary lens.

FIGS. 13-18 show various views of an exemplary imaging system including an object positioned relative to an exemplary lens of the exemplary imaging system.

FIGS. 19-23 show views including various light rays passing before and through an exemplary lens of an exemplary imaging system.

FIGS. 24-28 show a perspective view, side view, top view of an exemplary lens included in an exemplary imaging system based on one implementation of the disclosed technology.

FIGS. 29-32B show various views of an exemplary imaging system including a recording device positioned relative to an exemplary lens of the exemplary imaging system.

FIGS. 33-35 show a conceptual view in which a viewer is provided with a holographic-like apparent image.

FIGS. 36-38 show various views of an exemplary imaging system including two lenses that are positioned relative to each other.

FIGS. 39 and 40 show light rays passing before and after two lenses included in the exemplary imaging system.

FIGS. 41-44 show various views of an exemplary imaging system including a recording device positioned relative to two lenses of the exemplary imaging system.

FIGS. 45-47 show conceptual views in which a viewer is provided with a holographic-like apparent image.

FIGS. 48-55 show various views of an implementation including segments taken from lenses to provide holographic effects.

FIGS. 56-59 show an implementation of an exemplary arrangement of two lens segments included in an exemplary imaging system and light rays passing before and after the two lens segments.

FIGS. 60-65 illustrate views from various angles along a sweet range when lens segments are placed in a right-angle arrangement.

FIGS. 66-70 illustrate rearrangement of a lens segment of two lens segments and light rays affected by the rearrangement.

FIGS. 71 and 72 show an implementation of an exemplary arrangement of two lens segments included in an exemplary imaging system and light rays passing before and after the two lens segments.

FIGS. 73-79 show various views of an arrangement where a cylinder lens segment, a disc lens segment, and a flat screen display are arranged in a proximal plane arrangement.

FIGS. 80-84 show an implementation of the disclosed technology including a Fresnel lens.

FIGS. 85-88 show various views indicating a possible location of a viewing arc in an exemplary imaging system including a Fresnel lens.

FIGS. 89-94 show an exemplary imaging system including a ‘TV’ Fresnel lens.

FIGS. 95-103 show a variety of utility, arrangements, and applications of the disclosed technology.

FIGS. 104-113 show various views of an exemplary imaging system including an exemplary lens based on one implementation of the disclosed technology.

FIGS. 114-119 illustrate rearrangement of a lens segment of two lens segments and light rays affected by the rearrangement.

FIGS. 120-127 show applications employing the disclosed technology.

FIGS. 128-133 show other applications employing the disclosed technology.

FIGS. 134-141 show implementations where a stereoscope is used to view an apparent image provided based on one implementation of the disclosed technology.

FIGS. 142-145 show implementations where a viewer can view an apparent image as holographic without a stereoscope.

FIGS. 146-150 show possible applications of the disclosed technology.

FIGS. 151-154 show implementations of the disclosed technology including a cone lens arranged with a disc lens based on one implementation of the disclosed technology.

FIG. 155 shows a theater arrangement in which the disclosed technology is applied.

FIGS. 156-158 show implementations of the disclosed technology providing a holographic page reader.

FIG. 159 shows an implementation of the disclosed technology providing a holographic driver license.

FIGS. 160 and 161 show an implementation where a viewer can view an apparent image provided based on one implementation of the disclosed technology.

FIGS. 163-170 show various embodiments of the disclosed technology using a mirror or mirrors, or a combination of one or more mirrors or lens.

FIGS. 171-180 show various examples of the disclosed technology to display an apparent image.

FIGS. 181 to 185 illustrate some implementations of the disclosed technology to allow a viewer to perceive an apparent depth of an image.

### DETAILED DESCRIPTION

In some existing imaging technologies, an imaging system may use a stereoscopic effect showing two slightly different flat images, which may create the appearance of depth. The term “flat” in the flat images refers to the characteristics of the images lacking at least some apparent depth and is not about the shapes of the images. Thus, the flat images may have various shapes and topologies. For example, a photograph printed as a picture in a newspaper may lack some perception of depth when viewed but can be curved or folded as the newspaper's topology changes. This change in topology may not normally affect that the printed photograph may lack some or all apparent depth. Under such implementations of the disclosed technology, these images may only have the appearance of depth from a single viewpoint. Some existing systems may be used to show apparent motion, and may use existing flat image technology, however they generally use additional equipment such as glasses or other headgear. Some existing systems may create multiple, but unconnected viewpoints, without the use of glasses or headgear. This leaves gaps in the viewing experience, which are not 3D. Some existing holographic systems use specialized materials and lasers to record and project still images but cannot simulate motion by rapidly changing or replacing the still images.

The disclosed techniques can be implemented to provide an imaging system which provides virtual reality effects, for example, 3D or holographic effects and provide an imaging system which views an image with the virtual reality effects. Some implementations of the disclosed technology may record and provide a holographic-like image by projecting a single flat, two-dimensional image. Some implementations of the disclosed technology may record and show a holographic-like image that is viewed from a related range of viewpoints more than one viewer at the same time. According to the disclosed technology, it is possible to provide a holographic-like image by utilizing an existing flat image technology without the use of any additional devices.

The disclosed technology is capable of being utilized with existing two-dimensional, or flat imaging technologies to record and project holographic-like images without any modifications on the currently existing equipment. The disclosed technology is capable of being utilized to record or display holographic-like images at a frame rate or simulated motion of the currently existing equipment without any modifications. Implementations of the disclosed technology may be added to existing mass production equipment and methods with relatively minor modifications compared to other technologies. The disclosed technology also allows the currently existing flat images to be viewed in the same manner as when using the currently existing flat image technology. For instance, the 1939 film ‘The Wizard of Oz’ could be still displayed as a non-3D, non-holographic image by using the disclosed technology.

Some implementations of the disclosed technology may record and provide a holographic-like image using flat images. The disclosed technology may be implemented using various technologies and methods such as printed materials, projection onto a screen, or displays employing CRT or other various technologies commonly referred to as the flat screen. The disclosed technology may also be implemented by using curved or other non-flat versions of these technologies. Some implementations of the disclosed technology may display images whether recorded or otherwise created, such as hand or machine made, or computer generated. It may also record images using flat image technologies, such as still cameras or video cameras using film or digital recording. The disclosed technology may also allow the perception of seemingly flat or two dimensional apparent images that, such as, but not limited to, existing television or theater projections. This perception of the seemingly flat images may vary from simple points of light to greater detail, as an example, as may be seen in a photograph.

Some implementations of the disclosed technology provide a lens or lenses for recording an image. The image recorded is then projected or viewed through the same or similar lens or lenses. This allows the viewer to perceive an image that can be described as holographic. The recorded image viewed alone, without the lenses, may appear distorted to the viewer. This image contains all of the visual information needed to show the holographic-like image. Nearly any known two-dimensional image systems can be used to record or display the image. Images to be viewed through the lens or lenses may also be created by hand, mechanism, or computer, without ever being recorded through the lens or lenses used. These images as received by the imaging means, require no manipulation, modification, or processing of any kind to then be shown as a holographic-like image. For example, a Polaroid Camera commonly available in the 1970's or 1980's in normal use with its normal film may produce a photograph that could provide the holographic-like effects that require no additional processing, manipulation, or modification to be used for the purpose of producing a holographic-like image.

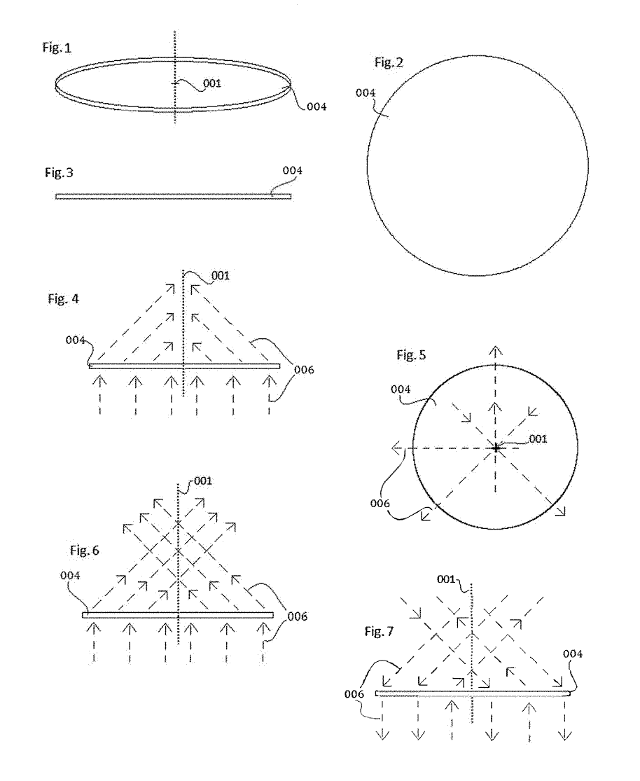

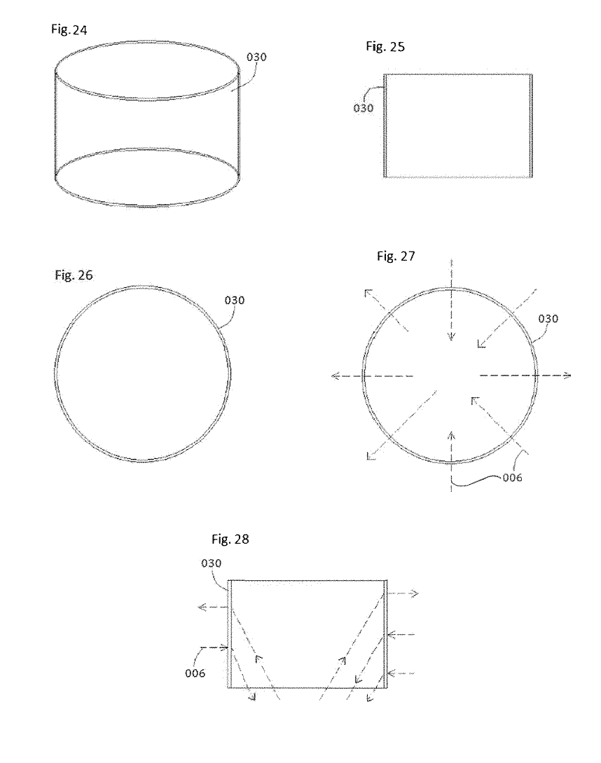

FIGS. 1-7 show an example of a lens that can be used to record an image according to some implementations of the disclosed technology. FIGS. 1-3 show the perspective view, top view and side view of the lens and FIGS. 4-7 show various light rays passing before and through the lens 006. In FIGS. 1-7, a disc lens 004 is provided as one example, which is similar to a commonly available Fresnel lens page magnifier, such as found in bookstores. While FIGS. 1-7 show the disc lens 004 as an example, other implementations are also possible. For example, FIGS. 24-28 show a cylinder lens as will be discussed later and other lenses are also available. The disc lens 004 may include a material and be structured in a way that may appear to a casual observer to be visually similar to the Fresnel lens page magnifier. The disc lens 004 has a lens axis 001. In this example, a lens of about 18 inches/46 centimeters is used. In an example, this lens is placed in a horizontal position, relative to the horizontal plane of the viewing person's eyes, about mid chest level below the viewer's eye level, at a distance from the viewer so as to be at about 45 degree viewing angle. The holographic effect can be provided in the horizontal plane as it relates to average human beings, in a generally upright position relative to the Earth, and their generally horizontal eye placement at many times of the average person's day. The horizontal display may be seen as a simpler representation of the fuller effect that the disclosed technology may produce, but the disclosed technology is not limited thereto. For example, some implementations of the disclosed technology may show the effect from more than a horizontal display. A viewer may be able to see the holographic effect from a range of angles other than just horizontal. As in a viewer may be able to look down on or up at apparent objects and see the holographic effect also from those angles.

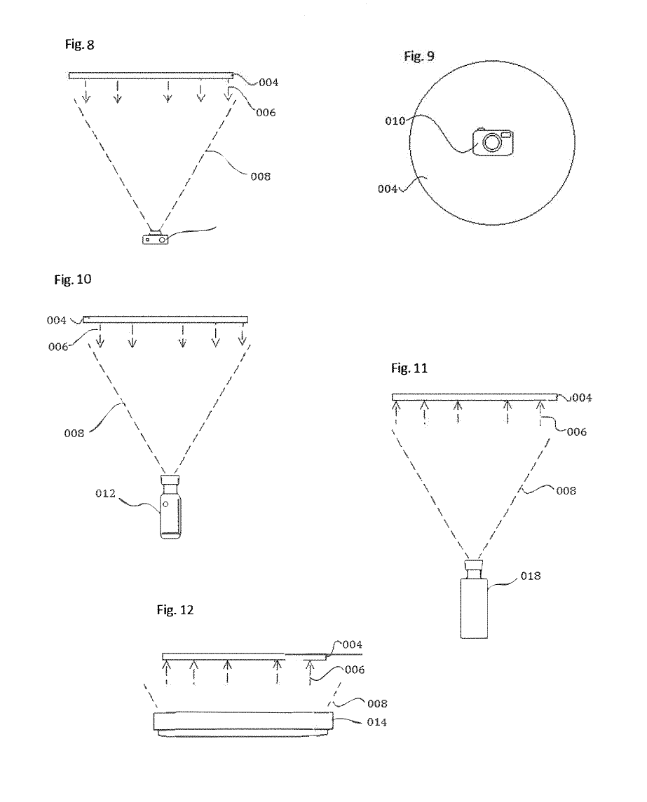

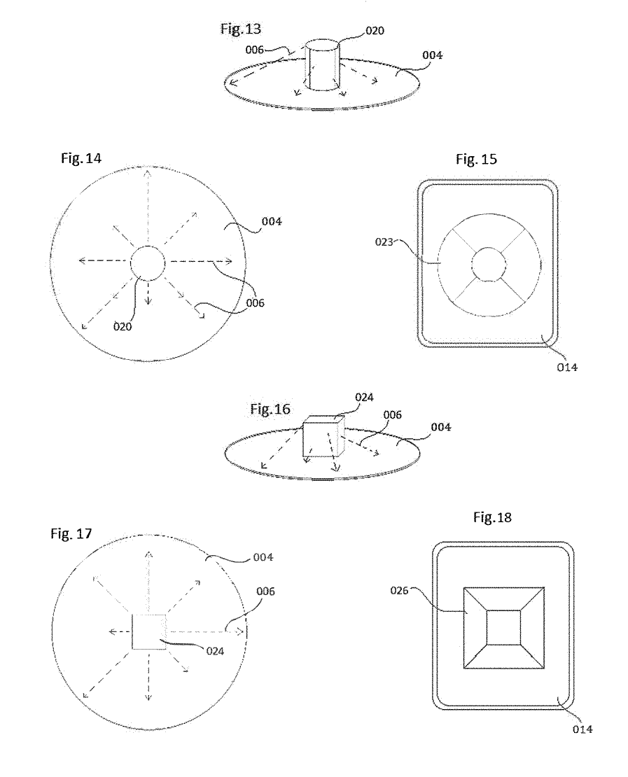

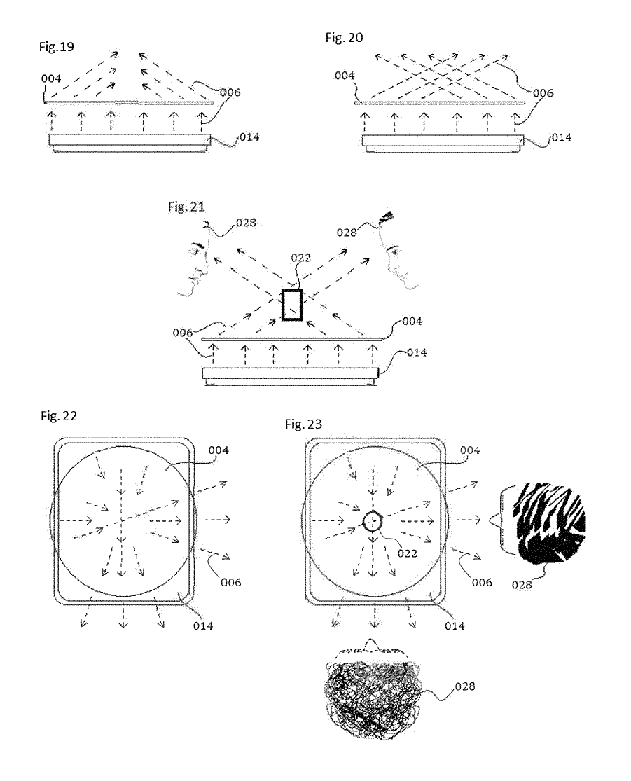

An object such as a standard sized Rubik's Cube, beverage, or bottle is placed on or about the center of the disc lens 004. In FIGS. 13-15, a can 020 has been used as the object and in FIGS. 16-18, a box 024 has been used as the object. In FIGS. 13-18, the object such as the can 020 and the box 024 are positioned around or on the axis 001 of the lens 004. Any recording devices including a standard still camera, a motion camera, or a flat screen display can be positioned to record an image of the object. For example, to record an image, the still camera 010 is provided in FIGS. 8 and 9, the video camera 012 is provided in FIGS. 10 and 11, and the flat screen display 014 is provided in FIGS. 12, 19 and 20. In some implementations, the camera is replaced with an image projector placed similarly to the camera, or an image display screen is positioned near the lens so as to show its image through the lens. The flat screen display may be not limited to have a display with the flat screen and include displays with non-flat screen including curved one.

FIGS. 21-23 show conceptual views in which the viewer 028 is provided with the holographic-like apparent image 022. Ambient or generated light is reflected from the object 020, 024, some of the light passes through the lens 004, and is aimed toward and received by the recording device 010, 012, 014. The recording device 010, 012, 014 records one or more images of the object 020, 024 as seen through the lens 003. To the viewer 028, this recorded image displayed by normal flat image methods, would seem distorted compared to an image not recorded through the lens. Light from the object passes through the lens, and is directed radially outward from the lens center, and at an angle from the plane of the lens. When the viewer is looking toward the lens, the light seen by a common binocular vision of a person viewing the image allows the viewer to perceive an apparent three-dimensional (3D) image of an imaged object which is positioned below the lens. If the viewer moves around the lens while maintaining the similar visual orientation, the viewer will perceive a changing, but apparently continuous three-dimensional view of the imaged object. The apparent image 022 of the object will be seen as three dimensional while viewed from different positions, showing a holographic-like image. A single flat, two-dimensional image recorded by the recording device such as the camera 010 and the flat screen 014 can appear as a holographic-like image. A single flat, two-dimensional image recorded by the recording device such as the camera 0101 and the flat screen 014 can appear as a holographic-like image, viewed simultaneously by both of the viewer's eyes.

FIGS. 24-28 show another example of an imaging system based on a curved lens shaped in a cylindrical shape that could be used to record an image according to some implementations of the disclosed technology. As an exemplary embodiment, the imaging system in FIGS. 24-28 show the curved lens but the lens used in the imaging system is not limited to the curved lens. For example, the lends can be flat or have a curvature. The perspective view, the front view, the top view of the cylinder lens 030 are illustrated in FIGS. 24-26 and FIGS. 27 and 28 show the light rays passing before and after the lens 030 in a top view and the front view.

FIG. 24 shows a perspective view of this example where the curved lens 030 is formed by an optical transparent lens material that is shaped in a cylindrical shape. FIG. 25 shows a side view of the curved lens 030 along a direction perpendicular to the geometrical axis of the cylindrical shape around which the optical transparent lens material is curved to form the cylindrical shape. FIG. 26 shows a side view of the curved lens 030 along the geometrical axis of the cylindrical shape. FIG. 27 illustrates several examples of light rays 006 in their respective directions at their local surfaces of the curved lens 030 when passing through the curved lens 030 and FIG. 28 further illustrates, in the side view of the curved lens 030 along a direction perpendicular to the geometrical axis of the cylindrical shape as shown in FIG. 25, several examples of light rays 006 in their respective directions at their local surfaces of the curved lens 030 when passing through the curved lens 030. More specifically, FIG. 28 shows that light rays from an image or object placed below the curved lens 030 will enter the inner side surface of the curved lens 030 and will be optically modified by the curved lens 030 to change the direction of each light ray along a particular direction after passing through the curved lens 030 at a particular direction. In this regard, different light rays at different incident directions at the inner side surface of the curved lens 030 may be optically modified by the curved lens 030 differently. Similarly, different light rays incident to the outer side surface of the curved lens 030 at different angles may be optically modified to emerge from the inner side surface of the curved lens 030 after passing through the sidewall at different light ray directions.

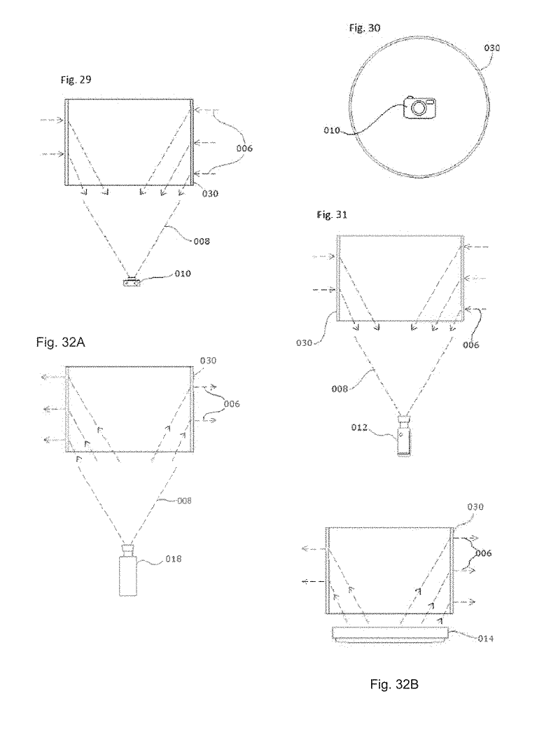

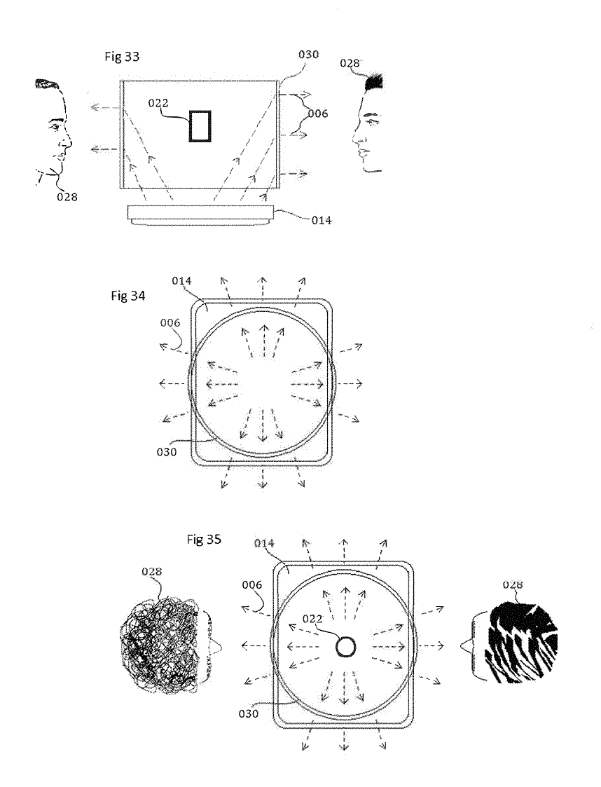

FIGS. 29-32B show an image recording operation based on the curved lens 030 shown in FIGS. 24-28 by placing an image recording device below the curved lens at a location at or near the geometrical axis of the cylindrical shape of the curved lens 030 to record an image of an object or a scene located at or surrounding the outer side surface of the curve lens 030. This image recording device can be implemented by different imaging recording devices, for example, a camera 010 (FIGS. 29 and 30), a video camera 012 (FIG. 31), a flat screen display 014 (FIG. 32B), or an image projector 018 (FIG. 32A). Under this recording operation, the still or moving images of one or more objects or a scene located at or surrounding the outer side surface of the curve lens 030 are captured via the curved lens 030 and thus the recorded still images or moving images (video) are optically modified images by the curved side surface of the curved lens 030 and thus different from images that are directly captured by the recording device in absence of the curved lens 030. After such optically modified still or moving images are recorded, the same or another but substantially similar or identical curved lens 030 may be used to render such recorded images to a viewer that views the recorded image via the curved lens 030. This viewing operation is explained below with reference to FIGS. 33-35.

FIGS. 33-35 show an example of the viewing operation by using a curved lens 030 in which a viewer 028 looks into the curved lens 030 via its side surface to receive a holographic-like apparent image 022 based on the projection of the recorded still or moving images. FIG. 33 shows an example of the image viewing system which uses a similarly or identically constructed curved lens 030 as the recording curved lens 030 for image rendering in which an imaging projection device, e.g., a flat screen display 014, is placed underneath the curved lens 030 to display recorded still or moving images, e.g., at a flat screen such as an LCD or OLED display screen. A portion of the light carrying the recorded still or moving images from the flat screen 014 reaches the curved lens 030 from the bottom opening of the curved lens 030 to the inner space surrounded by the curved side surface of the curved lens 030. Such light contains light rays from different parts of the flat screen 014 which reach to the curved inner side of the curved lens 030 at different locations or/and at different incident angles. Such light is further optically modified by the curved lens 030 differently based on their respective locations and incident angles on the inner side of the curved lens 030 when passing through the curved lens 030. The modified light rays emerge on the outer side of the curved lens 030 and are directed towards the eyes of the viewer 028. There can be more than one viewers 028 as shown in FIG. 33 in viewing the same rendered still or moving images at different locations around the curved lens 030 or a viewer 028 may move around the curved lens 030 to view the rendered still or moving images from different viewing locations.

In this viewing operation, the modified light rays emerging on the outer side of the curved lens 030 carry still or moving images of one or more objects or a scene as recorded via a similar or identical curved lens 030 using a recording process shown in FIGS. 29-32B. Due to the relationship of the recording and viewing operations, an object or a scene appears to the viewer 028 as a holographic like or in a 3D perception. As illustrated in the example in FIG. 33, a rendered image object 020 (e.g., a can) to the viewer 028 may appear to “float” or “suspend” inside (as shown) or outside the inner space of the curved lens 030, with an effect that can be used for entertainment purposes or for other applications that desire image displays beyond 2-D rendering.

FIG. 34 shows a top view of the light rays 006 from the image projection device 014 to the inner space of the curved lens 030 and emerging light rays from the side surface of the curved lens 030 towards a viewer 028. FIG. 35 shows how the emerging light rays from the side surface of the curved lens 030 towards a viewer 028 collectively appear to be originated from a 3-D object 022. A viewer 028 may view the rendered image 022 from different locations around the curved lens 030 and different viewers 028 may also look at the different parts of the same rendered image 022 at different locations outside the curved lens 030.

Based on the examples in FIGS. 24-35, an image display technique can be provided to use a curved lens that includes a cylindrical shape to display still or moving images in holographic or 3D like perceptions to one or more viewers looking through the curved lens. This technique includes a recording phase and a rendering phase. In the recording phase, a recording device is placed under the curved lens at or near the geometrical axis of the cylindrical shape to receive light rays from one or more objects or a scene located outside the curved lens and to record the received images of the one or more objects or the scene that are optically modified by the curved lens and are projected onto the recording device by the curved lens. The recorded images are stored in a storage device for subsequent rendering. In the rendering phase, a curved image-rendering lens that is similar or identical to the curved lens used in the recording phase is used and an image projection device such as a display screen or projector is placed under the curved image-rendering lens at or near the geometrical axis of the cylindrical shape of the image-rendering lens. The display screen or projector is used to display the above recorded still or moving images and the light rays from the displayed images are directed to the inner space of the curved image-rendering lens and to be optically modified by the lens as output rays to be perceived by one or more viewers looking at the curved image-rendering lens as if the light rays are from one or more objects or a scene located in or outside the inner space within the cylindrical shape of the lens. The use of the same or similar curved lenses in both the recording and the rendering operations is to introduce similar or identical optical distortions in the recording phase as in the rendering phase so that the reverse operation nature of the rendering phase would undo the distortions in the recorded images to generate the holographic like or 3D images in the rendering phase.

Some implementations of the disclosed technology can be configured to include two lenses for recording desired still or moving images and for rendering the recorded images as holographic like or 3D images. FIG. 36 shows an implementation example in which in addition to the curved cylinder lens 030 as shown in FIGS. 24, 29 and 33, an additional lens 004, such as a disc lens, is placed relative to the curved cylinder lens 030 in the path of the light rays in the recording and rendering operations. The cylinder lens 030 and the disc lens 004 are arranged to form a shape like a bucket. For example, the disc lens 004 is centered near one end of the cylinder lens 030 in a manner that resembles a bucket, hereafter referred to as the “bucket arrangement.” FIGS. 37 and 38 show a side view and a top view of the two-lens arrangement in FIG. 36 along two orthogonal directions. In this two-lens design, any light ray is optically modified by both lenses during the recording operation, and, in the image rendering operation, each light ray projected from the image projection device to a viewer is also optically modified by the two lenses.

FIG. 39 shows light rays relative to the cylinder lens 030 and the disc lens 004 placed in the bucket arrangement, with some light rays 006 passing through in multiple directions in both recoding and rendering operations. FIG. 40 shows, in a side view of the cylinder lens 030 and the disc lens 004 placed in the bucket arrangement, light rays 006 in their respective directions at their local surfaces of the cylinder lens 030 and the disc lens 004 when passing through the cylinder lens 030 and the disc lens 004. In particular, FIG. 40 shows that light rays from an image or object placed below the cylinder lens 030 and the disc lens 004 will arrive at the disc lens 004 and then enter the inner side surface of the cylinder lens 030. The light rays entering the inner side surface of the cylinder lens 030 will be optically modified by the cylinder lens 030 to change the direction of each light ray along a particular direction after passing through the cylinder lens 030 at a particular direction. In this regard, different light rays at different incident directions at the inner side surface of the cylinder lens 030 may be optically modified by the cylinder lens 030 differently. Similarly, different light rays incident to the outer side surface of the cylinder lens 030 at different angles may be optically modified to emerge from the inner side surface of the cylinder lens 030 after passing through the sidewall at different light ray directions. As shown in FIGS. 39 and 40, the light rays are optically modified by the cylinder lens 030 and the disc lens 004 during the recording operation and the image rendering operation, thereby providing holographic-like image viewing effects.

The combined arrangement of the cylinder lens 030 and the disc lens 004 may provide an additional optical effect where the directions of the light rays from one of the cylinder lens 030 and the disc lens 004 are changed due to the other of the cylinder lens 030 and the disc lens 004. For example, as some light leaves the disc lens 004 and encounters the cylinder lens 030, the cylinder lens may affect to altering its path horizontally in the bucket arrangement. The radial direction of the light may be less or not affected, as the surfaces of the cylinder lens 30 encountered by the light are basically in a plane at a right angle to the radial direction of the light. So the light may pass through the cylinder lens 030 with its radial direction somewhat unaffected, and continue on generally the same radial path. The additional optical effect provided by the combination of the cylinder lens 030 and the disc lens 004 may be referred to as a “pass through” effect.

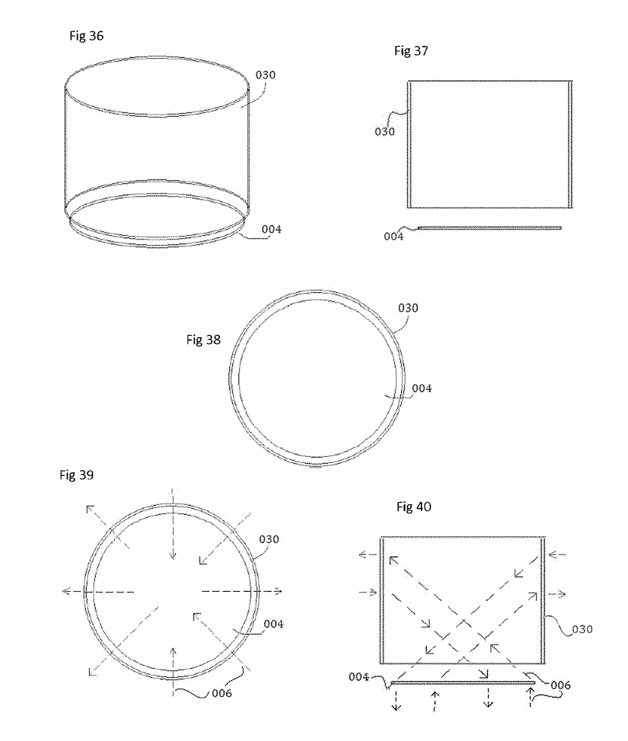

FIGS. 41-44 show an image recording operation based on the two-lens arrangement shown in FIGS. 36-40 by placing an imaging recording device below the two lenses at a location at or near the geometry axis of the two lenses to record an image of an object or a scene located at or surrounding the outer side surface of the cylinder lens 030. For example, the imaging recording device is centered on the geometry axis of the cylinder lens 030 to record the still or moving images of one or more objects or a scene located at or surrounding the outer side surface of the cylinder lens. This image recording device can be implemented by different imaging recording devices, for example, a camera 010 (FIG. 41), a video camera 012 (FIG. 42), an image projector 018 (FIG. 43), or a flat screen display 014 (FIG. 44). The two lenses, the cylinder lens 030 and the disc lens 004, are provided in the bucket arrangement such that the disc lens 004, the cylinder lens 030 and one of the imaging recording device 010, 012, 014 or 018 are located at or near the geometry axis of the two lenses. In this case, the disc lens 004 arranged below the cylinder lens 030 operates to receive still or moving images from the imaging recording device 010, 012, 014, or 018 and the cylinder lens 030 arranged above the disc lens 004 operates to optically modify the still or moving images to create a holographic-like perception to a viewer. The recorded still images or moving images are optically modified images by the curved side surface of the cylinder lens 030 and thus different from images that are directly captured by the recording device in absence of the cylinder lens 030. After such optically modified still or moving images are recorded, the same or another but substantially similar or identical cylinder lens 030 may be used to render such recorded images to a viewer that views the recorded images via the cylinder lens 030. This viewing operation is explained below with reference to FIGS. 45-47.

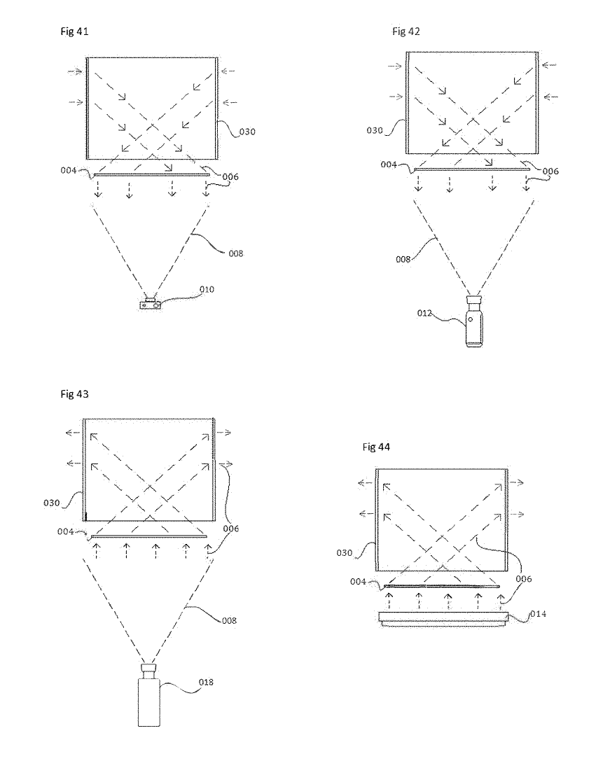

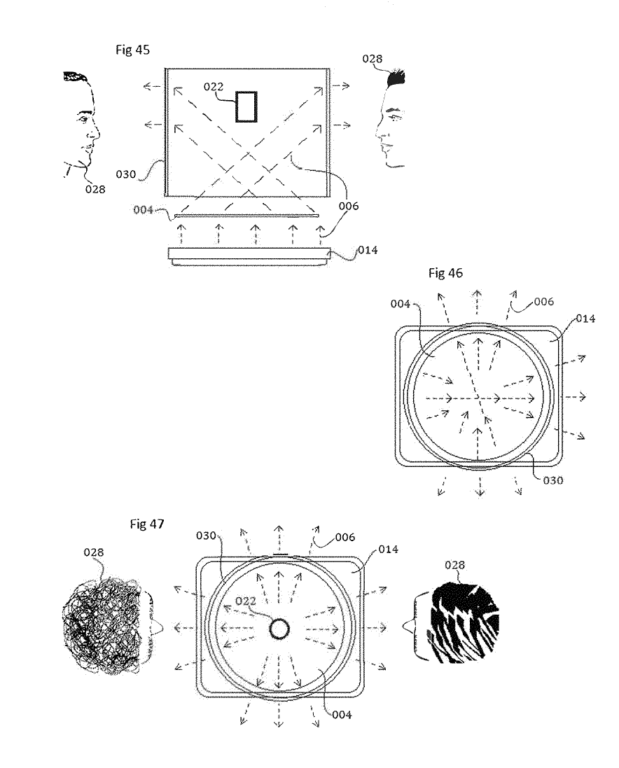

FIGS. 45-47 show an example of the viewing operation by using two lenses 030 and 004 in which a viewer 028 looks into the cylinder lens 030 via its side surface to receive a holographic-like apparent image 022 based on the projection of the recorded still or moving images. FIG. 45 shows a side view of the cylinder lens 030 along the geometrical axis of the cylinder lens 030 and FIGS. 46 and 47 show a plan view of the cylinder lens 030 along a direction perpendicular to the geometrical axis of the cylinder lens 030. FIG. 45 shows an example of the image viewing system which uses a similarly or identically constructed cylinder lens 030 as the recording cylinder lens 030 for image rendering in which an imaging projection device, e.g., a flat screen display 014, is placed underneath the cylinder lens 030 and the disc lens 004. In some implementations, the disc lens 004 and the cylinder lens 030 are placed in the bucket arrangement and the flat screen display 014 is placed to be centered with the disc lens 004. The viewer(s) 028 is positioned such that the eye level of the viewer(s) 028 is about midway between a top and a bottom of the cylinder lens 030. The binocular vision of the viewer(s) 028 looking the recorded still or moving images can be provided with the perception of a holographic-like apparent image 022. In some implementations, the flat screen display 014 is placed in proximity to the bucket arrangement and oriented to be proximate to the disc lens 004, with the surface plane of the flat screen display 014 parallel to the surface plane of the disc lens 004. In some implementations, the cylinder lens 030 is placed to be proximate to the disc lens 004 in the bucket arrangement.

A portion of the light carrying the recorded still or moving images from the flat screen 014 reaches the disc lens 004 and then enters the inner space of the cylinder lens 030 which is surrounded by the curved side surface of the cylinder lens 030. Such light contains light rays from different parts of the flat screen 014 when reach to the curved inner side of the cylinder lens 030 at different locations or/and at different incident angles. Such light is further optically modified by the cylinder lens 030 differently based on their respective locations and incident angles on the inner side of the cylinder lens 030 when passing through the cylinder lens 030. The modified light rays emerge on the outer side of the cylinder lens 030 and are directed towards the eyes of the viewer 028. There can be more than one viewers 028 as shown in FIG. 45 in viewing the same rendered still or moving images at different locations around the cylinder lens 030 or a viewer 028 may move around the cylinder lens 030 to view the rendered still or moving images from different viewing locations.

In this viewing operation, the modified light rays emerging on the outer side of the cylinder lens 030 carry still or moving images of one or more objects or a scene as recorded via a similar or identical cylinder lens 030 using a recording process shown in FIGS. 41-44. Due to the relationship of the recording and viewing operations, an object or a scene appears to the viewer 028 as a holographic like or in a 3D perception. As illustrated in FIG. 45, a rendered image objection 022 (e.g., a can) to the viewer 028 may appear to “float” or “suspend” inside (as shown) or outside the inner space of the cylinder lens 030, with an effect that can be used for entertainment purposes or for other applications that desire image displays beyond 2-D rendering. FIG. 46 shows a top view of the light rays 006 from the flat screen 014 to the inner space of the cylinder lens 030 and emerging light rays from the side surface of the cylinder lens 030 towards a viewer 028. FIG. 47 shows how the emerging light rays from the side surface of the cylinder lens 030 towards a viewer 028 collectively appear to be originated from a 3-D object 022. A viewer 028 may view the rendered image 022 from different locations around the cylinder lens 030 and different viewers 028 may also look at the different parts of the same rendered image 022 at different locations outside the cylinder lens 030. Based on the examples in FIGS. 36-47, an image display technique can be provided to use the cylinder lens 030 and the disc lens 004 to display still or moving images in holographic or 3D like perceptions to one or more viewers looking through the cylinder lens 030.

Some implementations of the disclosed technology can be configured using not only a fully-enclosed lens but also a partially-enclosed lens. FIGS. 48-55 show an example of imaging system in which segments of two lenses are configured to record desired still or moving images and render the recorded images as holographic like or 3D images. In some implementations, the segments of two lenses include a cylinder lens segment 32 taken from the cylinder lens 030 and a disc lens segment 038 taken from the disc lens 004. FIG. 48 shows a perspective view of the example how the cylinder lens segment 32 and the disc lens segment 038 are taken from the cylinder lens 030 and the disc lens 004, respectively. In FIG. 48, the cylinder lens 030 including the cylinder lens segment 032 and the disc lens 004 including the disc lens segment 038 are placed in the bucket arrangement. The segments taken from the cylinder lens 030 and the disc lens 004 are arranged relative to each other. For example, FIG. 49 shows that the disc lens segment 038 is placed to support the cylinder lens segment 032 and the cylinder lens segment 032 is placed on the disc lens segment 038. Since the cylinder lens segment 032 is only a segment of the cylinder lens 030 and is not fully enclosed, the cylinder lens segment 032 is located on one side of the disc lens segment 038. Exemplary arrangement as shown in FIG. 49 shows that the cylinder lens segment 32 is placed upright on a right side of the disc lens segment 038 and thus, the arrangement of the cylinder lens segment 032 and the disc lens segment 038 as shown in FIG. 49 is referred to as the right angle arrangement. The right angle arrangement as shown in FIG. 49 is one exemplary implementation only and other different arrangements can be configured to provide the imaging system based on the disclosed technology. For example, the angle formed between the cylinder lens segment 032 and the disc lens segment 038 can be variously changed. In some implementations, the location where the cylinder lens segment 032 is placed relative to the disc lens segment 038 is not limited to the right side of the disc lens segment and other implementations are also possible. For example, the cylinder lens segment 032 can be placed on various portions including a left side, an upper side, and a lower side of the disc lens segment 038. FIGS. 50 and 53 show perspective views of the cylinder lens segment 32 and the disc lens segment 038. FIGS. 51 and 52 illustrate, in the top view and the side view of the cylinder lens segment 032, respectively, examples of light rays 006 in their respective directions at their local surfaces of the cylinder lens segment 032 when passing through the cylinder lens segment 032. FIGS. 53 and 54 illustrate, in the top view and the side view of the disc lens segment 038, respectively, examples of light rays 006 in their respective directions at their local surfaces of the disc lens segment 038 when passing through the disc lens segment 038. Referring to examples in FIGS. 54 and 55, the light rays 006 from an image or object moves along an upper right direction to enter the inner side surface of the cylinder lens segment 032. The light rays entering the inner side surface of the cylinder lens segment 032 will be optically modified by the cylinder lens segment 032 to change the direction of each light ray along a particular direction after passing through the cylinder lens segment 032 at a particular direction. In this regard, different light rays at different incident directions at the inner side surface of the cylinder lens segment 032 may be optically modified by the cylinder lens segment 032 differently. Similarly, different light rays incident to the outer side surface of the cylinder lens 032 at different angles may be optically modified to emerge from the inner side surface of the cylinder lens 032 after passing through the sidewall at different light ray directions.

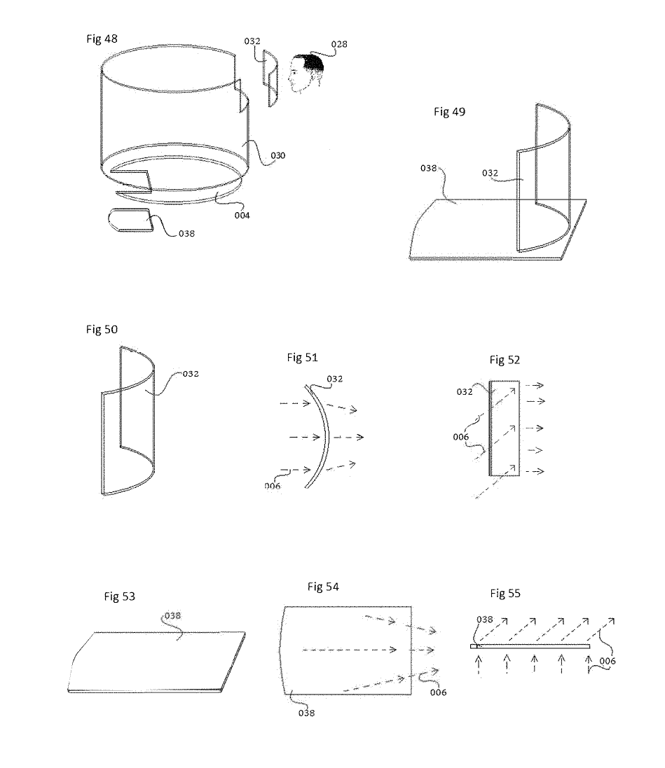

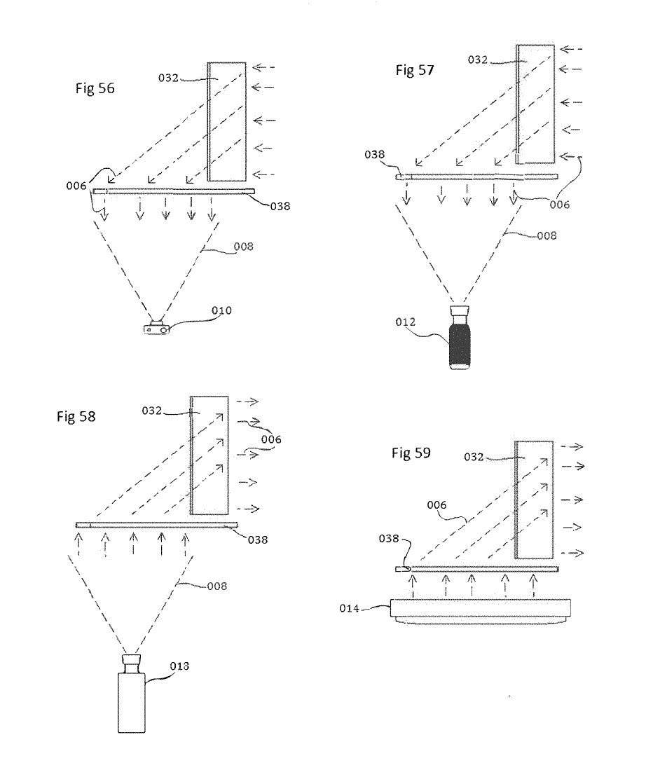

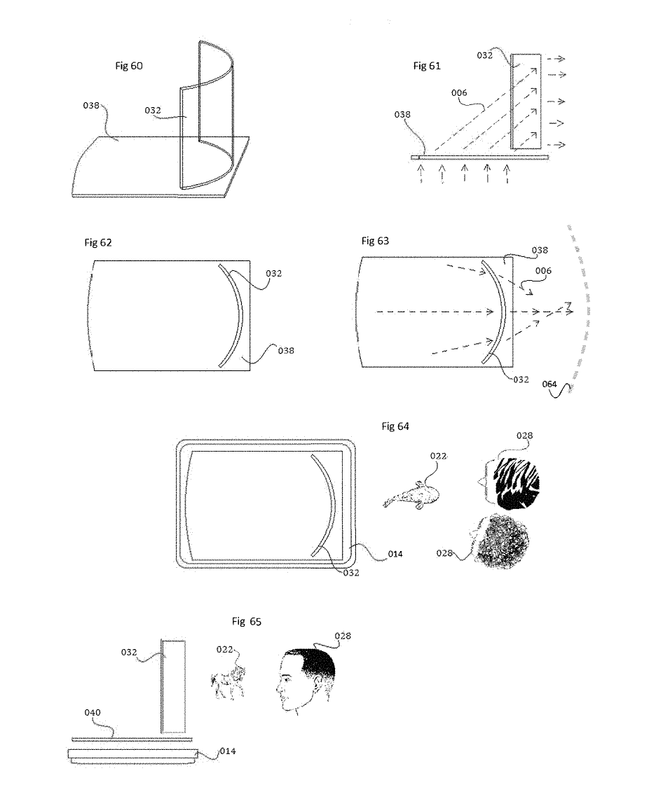

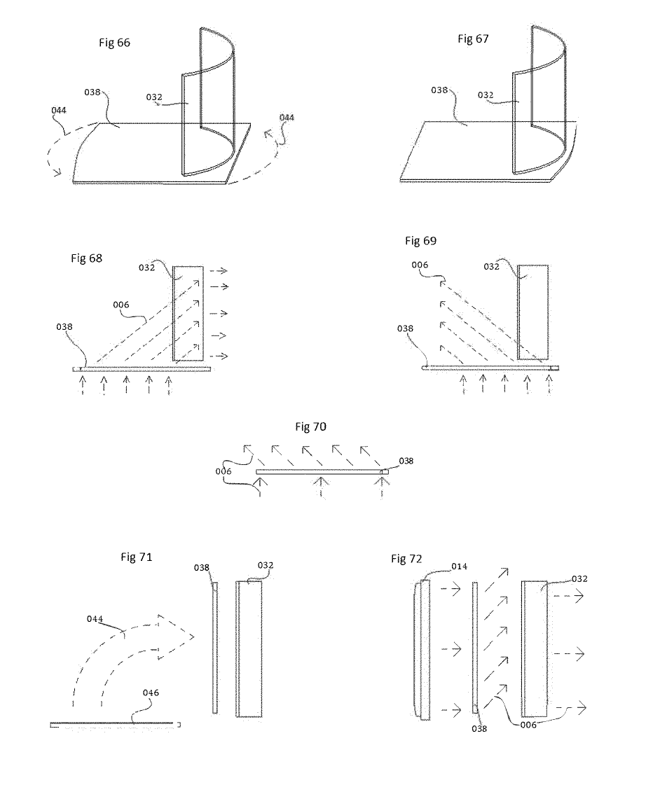

FIGS. 56-59 show an image recording operation based on the cylinder lens segment 032 and the disc lens segment 038 placed in the right angle arrangement as shown in FIGS. 48-55 by placing an image recording device below the cylinder lens segment 032 and the disc lens segment 038 to record an image of an object or a scene located at or surrounding the outer side surface of the cylinder lens segment 032. The image recording device can be implemented by different imaging recording devices, for example, a camera 010 (FIG. 56), a video camera 012 (FIG. 57), an image projector 018 (FIG. 58) or a flat screen display 014 (FIG. 59). The two lens segments, the cylinder lens segment 032 and the disc lens segment 038, are provided in the right angle arrangement such that the disc lens segment 038 arranged below the cylinder lens segment 038 operates to receive the recorded still or moving images from the imaging recording device 010, 012, 014 or 018 and the cylinder lens segment 032 arranged above the disc lens segment 038 operates to optically modify the recorded still or moving images to create a holographic-like perception to a viewer. The recorded still images or moving images are optically modified images by the curved side surface of the cylinder lens segment 032 and thus different from images that are directly captured by the recording device in absence of the cylinder lens segment 032. After such optically modified still or moving images are recorded, the same or another but substantially similar or identical cylinder lens segment 032 may be used to render such recorded images to a viewer that views the recorded images via the cylinder lens segment 032. This viewing operation is explained below with reference to FIGS. 60-65.

FIGS. 60-65 illustrate an example of a viewing operation by using a cylinder lens segment 032 and a disc lens segment 038. FIGS. 60 and 62 respectively show a perspective view and a top view of the cylinder lens segment 032 and the disc lens segment 038 that are arranged in the right angle arrangement. FIGS. 61 and 63 illustrate, in the side view and the top view, respectively, several examples of light rays 006 in their respective directions at their local surfaces of the cylinder lens segment 032 when passing through the cylinder lens segment 032. In FIG. 63, a viewing arc 064 is indicated when the cylinder lens segment 032 and the disc lens segment 038 are placed in the right-angle arrangement. As shown in FIG. 63, the light rays 006 can provide the viewing arc 064 with a working viewing range within which a viewer can perceive holographic like or 3D images. FIGS. 64 and 65 show an example of the viewing operation by using the cylinder lens segment 032 and the disc lens segment 038 that are placed in the right angle arrangement. The viewing operation proceeds using a similarly or identically constructed cylinder lens segment 032 as the recording cylinder lens segment 032 for image rending in which an imaging projection device, e.g., a flat screen display 014, is placed underneath the disc lens segment 038 to display recorded still or moving images, e.g., at a flat screen such as an LCD or OLED display screen. There can be more than one viewers 028 as shown in FIG. 64 in viewing the same rendered still or moving images at different locations around the cylinder lens segment 038 or a viewer 028 may move around the cylinder lens segment 038 to view the rendered still or moving images from different viewing locations. In this viewing operation, the modified light rays emerging on the outer side of the cylinder lens segment 038 carry still or moving images of one or more objects or a scene as recorded via a similar or identical cylinder lens segment 038 using a recording process shown in FIGS. 56-59. Due to the relationship of the recording and viewing operations, an object or a scene appears to the viewer 028 as a holographic like or in a 3D perception. As illustrated in the example in FIGS. 64 and 65, a rendered image object 022 (e.g., a fish or dog shaped objects) to the viewer 028 may appear to “float” or “suspend” inside or outside (as shown) of the cylinder lens segment 038 with an effect that can be used for various purposes including the entertainment and others.

Some implementations of the disclosed technology can include the disc lens segment 038 and the cylinder lens segment 032 that are arranged in different manners from the right angle arrangement as shown in FIGS. 49-65. FIGS. 66-70 illustrate variations of the right angle arrangement in which the disc lens segment 038 is arranged relative to the cylinder lens segment 032. FIGS. 66 and 67 show a view of the cylinder lens segment 032 and the disc lens segment 038 that are placed in the right angle arrangement. FIG. 66 shows the cylinder lens segment 032 and the disc lens segment 038 before the movement/rotation of the disc lens segment 038 and the arrow(s) in FIG. 66 shows the possible movement/rotation of the disc lens segment 038. FIG. 67 shows the cylinder lens segment 032 and the disc lens segment 038 that have been rearranged after the rotation of the disc lens segment 038. In FIGS. 66 and 67, the cylinder lens segment 032 does not change its location and thus maintains the same placement and orientation as before the rotation, while the disc lens segment 038 is rotated and positioned back in place after the rotation. As a specific example, FIGS. 66 and 67 show the disc lens segment 038 having three straight edges and one curved edge. Other shapes of the disc lens segment 038 are also possible. FIG. 68 shows an example of light rays 006 in their respective directions at their local surfaces of the disc lens segment 038 and the cylinder lens segment 032 that are arranged in the right angle arrangement as shown in FIG. 66. FIG. 69 shows an example of light rays 006 in the disc lens segment 038 and the cylinder lens segment 032 that are rearranged after the rotation of the disc lens segment 038 as shown in FIG. 67. As compared to the light rays in FIG. 68, the disc lens segment 038 that has been rotated changes the direction of the light rays passing through the disc lens segment 038 such that the light rays do not enter the inner side surface of the cylinder lens segment 032. FIG. 70 shows an example of the light rays 006 passing through the disc lens segment 038 when the disc lens segment 038 is rotated and rearranged after the rotation. Referring to the exemplary light rays in FIGS. 68-70, the disc lens segment 038 which has not rotated allow the light rays 006 passing through the disc lens segment 038 to enter the inner side surface of the cylinder lens segment 032 and the disc lens segment 038 which has been rotated allow the light rays 006 passing through the disc lens segment 038 to proceed to the outer side surface of the cylinder lens segment 032. Accordingly, the direction of the light rays 006 passing through the disc lens segment 038 can be adjusted by rotating the disc lens segment 038.

FIGS. 71-79 show other examples of an imaging system based on the disc lens segment 038 and the cylinder lens segment 032 that are in parallel arrangement relative to each other. FIG. 71 illustrates the imaging system where the disc lens segment 038 and the cylinder lens segment 032 are arranged in parallel along a geometrical axis of the cylinder lens segment 032. To facilitate the understanding of the parallel arrangement of the disc lens segment 038 and the cylinder lens segment 032, FIG. 71 shows the dotted arrow showing the movement of the disc lens segment 038 from the original position 046 (when the disc lens segment 038 is in the right angle arrangement with the cylinder lens segment 032) to the current position (when the disc lens segment 038 and the cylinder lens segment 032 are arranged in parallel with respect to each other). Referring to FIG. 71, the disc lens segment 038 is placed along a vertical direction, while the original position 046 is along a horizontal direction.

FIGS. 72 and 73 show an image recording operation based on the disc lens segment 038 and the cylinder lens segment 032 that are arranged in parallel to each other as shown in FIG. 71. In FIGS. 72 and 73, the flat screen display 014, the disc lens segment 038, and the lens segment 032 are arranged in parallel relative to one another. For example, the flat screen display 014, the disc lens segment 038, and the lens segment 032 are arranged in parallel along a longitudinal direction of the flat screen display 014, the disc lens segment 038, or the lens segment 032. To record an image of an object or a scene, an imaging recording device is placed at one side of the disc lens segment 038. In some implementations, the imaging recording device is located to be parallel with the disc lens segment 038 and the cylinder lens segment 032. While the image recording device can be implemented by various imaging recording devices, a flat screen display 014 is illustrated in FIGS. 72 and 73. FIGS. 72 and 73 illustrate, in a side view and a top view of the cylinder lens segment 032, respectively, exemplary light rays 006 in their respective directions when passing through the disc lens segment 038 and the cylinder lens segment 032. Under this recording operation, the images of one or more objects or a scene are received by the disc lens segment 038 from the flat screen display 014 and then captured via the cylinder lens segment 032. The cylinder lens segment 032 operates to optically modify the recorded images through the curved side surface of the cylinder lens segment 030. It may be noted that some light rays 006 proceeding from the disc lens segment 038 to the cylinder lens segment 032 placed in the parallel arrangement relative to the disc lens segment 038 have the same angle with the angle of the light rays 006 proceeding from the disc lens segment 038 to the cylinder lens segment 032 placed in the right angle arrangement relative to the disc lens segment 038. Thus, even with the movement of the disc lens segment 038 from the original position 046 to the position in parallel with the cylinder lens segment, some light rays 006 proceeding from the disc lens segment 038 to the cylinder lens segment 032 has not been changed. Thus, the parallel arrangement of the disc lens segment 038 and the cylinder lens segment 032 can be used to provide a similar or identical optical modification of the recorded images as the right angle arrangement of the disc lens segment 038 and the cylinder lens segment 032.

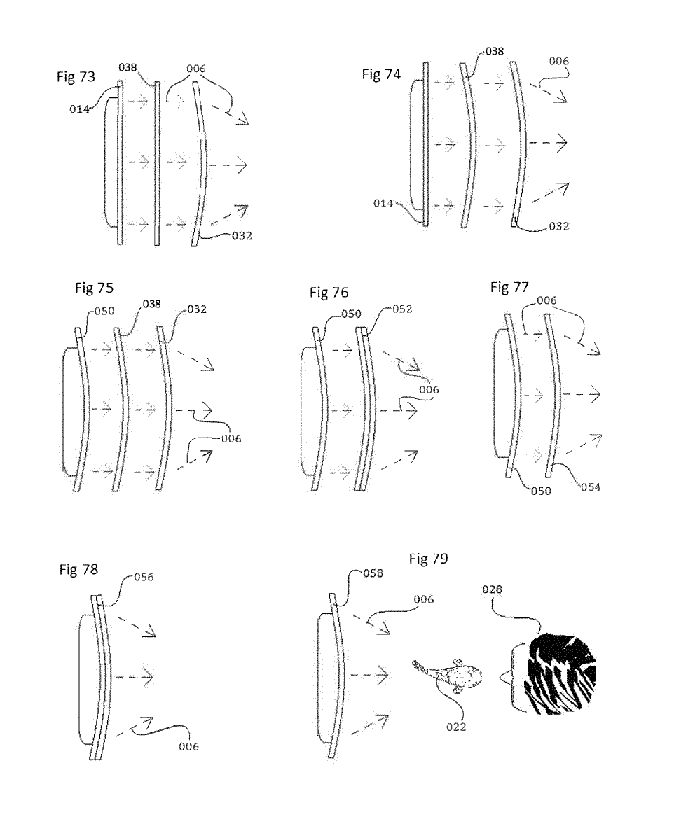

FIGS. 74-78 show exemplary variations of a parallel arrangement of a cylinder lens segment 032 and the disc lens segment 038. FIG. 74 shows an example of the disc lens segment 038 that is convexly curved as similar to or same as the cylinder lens segment 032. FIG. 75 shows an example of the flat screen display 014 which is convexly curved as similar to or same as the cylinder lens segment 032 and/or the disc lens segment 038. In FIG. 75, the flat screen display 014 which is convexly curved is indicated as a convex curved flat screen display 050. FIG. 76 shows an exemplary imaging system based on combined lenses 052 placed in parallel with a convex curved flat screen display 050. The combined lenses 052 may be formed by incorporating the cylinder lens segment 032 with the disc lens segment 038. FIG. 77 shows an exemplary imaging system based on a single lens 054 placed in parallel with a convex curved flat screen display 050. The single lens 054 made as a single piece may comprise optical properties of the cylinder lens segment 032 and the disc lens segment 038. FIG. 78 shows an exemplary imaging system where a single lens 054 is arranged in parallel with a convex curved flat screen display 050 such that the singe lens 054 and the convex curved flat screen display 050 are adjacent to each other. In FIGS. 74-78, although the disc lens segment 038 and the flat screen display 050 are shaped to be convexly curved, other implementations are also possible. As discussed based on FIGS. 74-78, the disclosed imaging system can be implemented in various manners to provide a holographic-like or 3D perception. Some implementations of the imaging system can include the curved-shaped or flat-shaped disc lens segment 038 and/or the curved-shaped or flat-shaped flat screen display 050. Some implementations of an imaging system can include a lens as a singular unit or a combination of singular units.

FIG. 79 shows an example of the viewing operation by using a convex curved flat screen display lens 058 in which a viewer 028 looks into the convex curved flat screen display lens 058 to receive a holographic-like apparent image 022 based on the projection of the recorded still or moving images. For example, the convex curved flat screen display lens 058 can be a television capable of rendering images. A portion of the light carrying the recorded still or moving images reaches the convex curved flat screen display lens 058 and such light is further optically modified by the convex curved flat screen display lens 058 when passing through the convex curved flat screen display lens 058. The modified light rays emerge on the outer side of the convex curved flat screen display lens 058 and are directed towards the eyes of the viewer 028 as shown in FIG. 79. In this viewing operation, the modified light rays emerging on the outer side of the convex curved flat screen display lens 058 carry still or moving images of one or more objects or a scene as recorded. As illustrated in the example of FIG. 79, a rendered image object 022 (e.g., a fish-shaped object) to the viewer 028 may appear to “float” or “suspend” outside the convex curved flat screen display lens 058. In this manner, the imaging system allows the viewer 028 to perceive the two-dimensional image recorded by, for example, the television, as the apparent object 022 with a holographic-like or 3D effects. The rendered still or moving images can be viewed simultaneously by both of the viewer's eyes, and there can be more than one viewers 028 who view the rendered still or moving images at the same time.

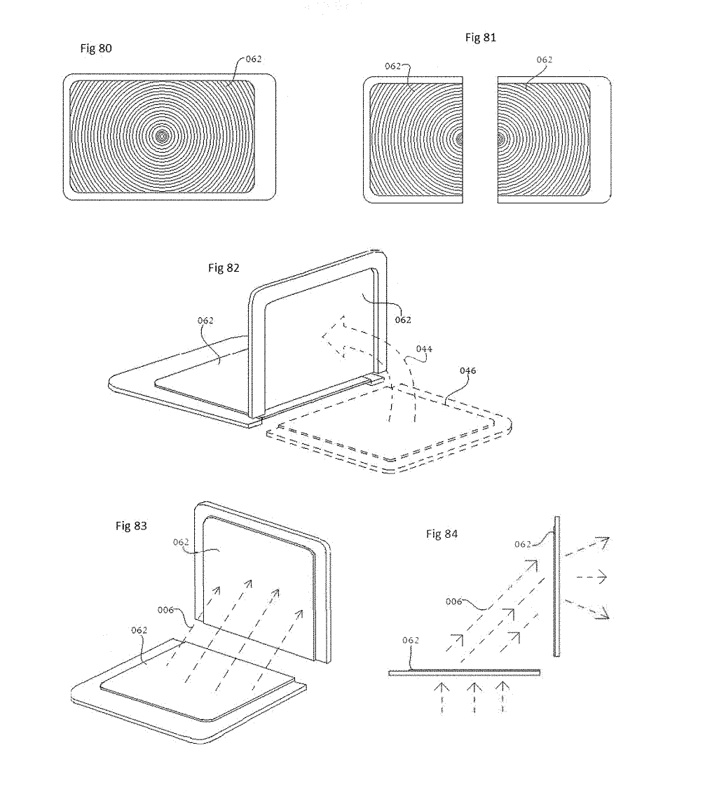

FIGS. 80-84 show examples of an imaging system based on a Fresnel lens. There exist various types of the Fresnel lens. For example, there is a commonly available ‘Reading’ Fresnel lens 062 which is shown in FIG. 80. FIG. 85 shows a possible location of a viewing arc 064 with a working viewing range within which a viewer can perceive holographic like or 3D images. As shown in FIGS. 81 and 82, the exemplary imaging system can be implemented to include two segments 062 of the Fresnel lens which are obtained by cutting across the center of focus of the Fresnel lens. FIG. 82 shows an exemplary arrangement of the two segments 062 of the Fresnel lens to provide a holographic-like or 3D perception. In FIG. 82, one of the two segments 062 is positioned along a direction parallel to a surface of the segment 062 and the other of the two segments 062 is positioned to be perpendicular to the one of the two segments 062. Thus, the two segments 062 are arranged orthogonal relative to each other (see the dotted portions in FIG. 82). FIG. 83 shows examples of light rays 006 in their respective direction when some light rays 006 move between the two segments 062 of the Fresnel lens. FIG. 84 shows, in the side view of the two segments 062 of the Fresnel lens, examples of light rays 006 in their respective directions at their local surfaces of the two segments 062 when passing from one segment 062 to the other segment 062 of the two segments 062 of the Fresnel lens. More specifically, FIG. 84 shows that light rays 006 from an image or object placed below one of the segment 062 will enter the inner surface of the other of the segment 062 and will be optically modified by the other segment 062 to change the direction of each light ray along a particular direction. Such optical modification occurring through the segments 062 of the Fresnel lens allows the imaging system to provide a holographic-like or 3D perception to a viewer. FIGS. 86-88 show examples of an imaging system based on a Fresnel lens. In FIGS. 86-88, one additional segment 062 is arranged underneath of the two segments 062 which are arranged as shown in FIGS. 82-84. FIGS. 86 and 88 show, at different angles in the perspective view, the viewing arc 064 when the three segments 062 of the Fresnel lens 060 are arranged as shown in FIGS. 86-88. The viewing arc 064 illustrates a working viewing range within which a viewer can perceive holographic like or 3D images in the imaging system based on three segments 062. FIG. 87 shows, in the side view of the three segments 062 of the Fresnel lens, exemplary light rays passing among the three segments 062. More specifically, FIG. 87 shows that light rays from an image or object placed below the first segment 062 which is positioned at the bottom will enter the first segment 062 and then the second segment 062 which is positioned between the two segments 062. The light rays proceed from the second segment 062 to the third segment 062 which is positioned to be orthogonal to the second segment 062 and will be optically modified by the third segment 062 to change the direction of each light ray along a particular direction.

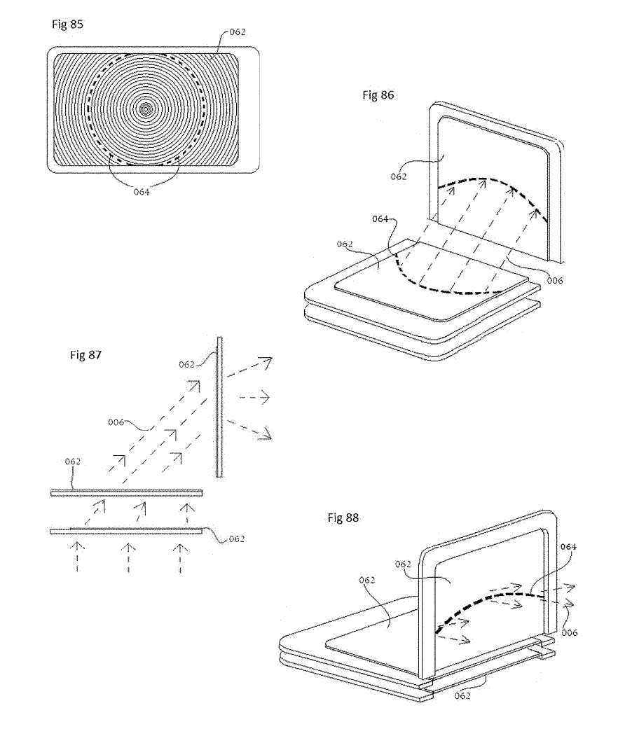

FIGS. 89-94 show examples of an imaging system based on a ‘TV’ Fresnel lens 066. While various rear screen projection televisions are available on the market, some implementations of the disclosed technology include segments of the ‘TV’ Fresnel lens 066 as shown in FIG. 89 to produce the desired holographic-like or 3D effects. FIG. 90 shows how the segments 068 are obtained from the ‘TV’ Fresnel lens 066. Referring to FIG. 90, some portions of the ‘TV’ Fresnel lens 066 are removed and prepared as ‘TV’ Fresnel lens segment 068, to configure the imaging system to provide holographic-like or 3D effects. These ‘TV’ Fresnel lens segments 068 may be removed from any portions of the ‘TV’ Fresnel lens 066. FIG. 91 shows the exemplary imaging system in which the ‘TV’ Fresnel lens segments 068 are arranged to be orthogonal to each other. FIG. 92 also shows two ‘TV’ Fresnel lens segments 068 in which one of the segment 068 is positioned upright relative to the other of the segment 068. FIG. 93 shows, in the side view of the ‘TV’ Fresnel lens segments 068, examples of the light rays in their respective directions at their local surfaces of the two segments 068 when passing from one segment 068 to the other segment 068 of the Fresnel lens. More specifically, FIG. 93 shows that light rays 006 from an image or object placed below one of the segment 068 will enter the inner surface of the other of the segment 068 and will be optically modified by the other segment 068 to change the direction of each light ray along a particular direction. Such optical modification occurring through the segments 068 of the Fresnel lens allows the imaging system to provide a holographic-like or 3D perception to a viewer. FIG. 94 shows a variation of the imaging system based on ‘TV’ Fresnel lens segments 068. In FIG. 94, one additional segment 068 is arranged underneath the two segments 068 which are arranged as shown in FIGS. 91-93.

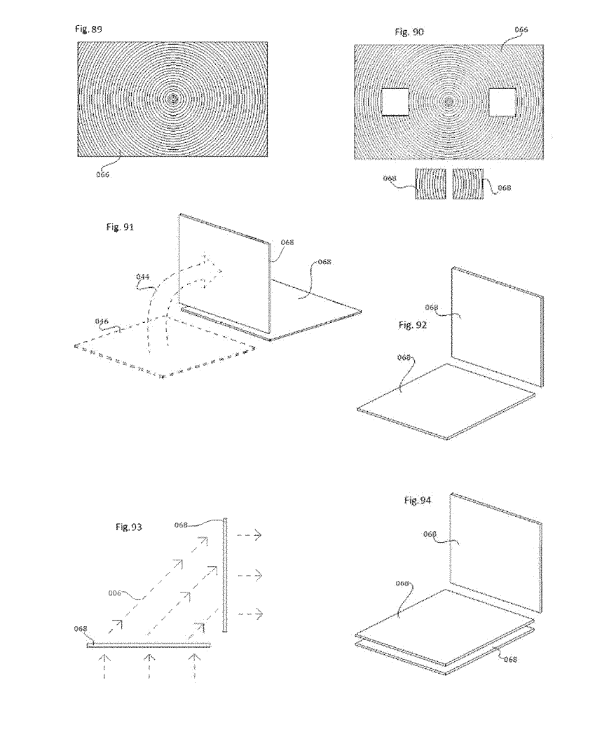

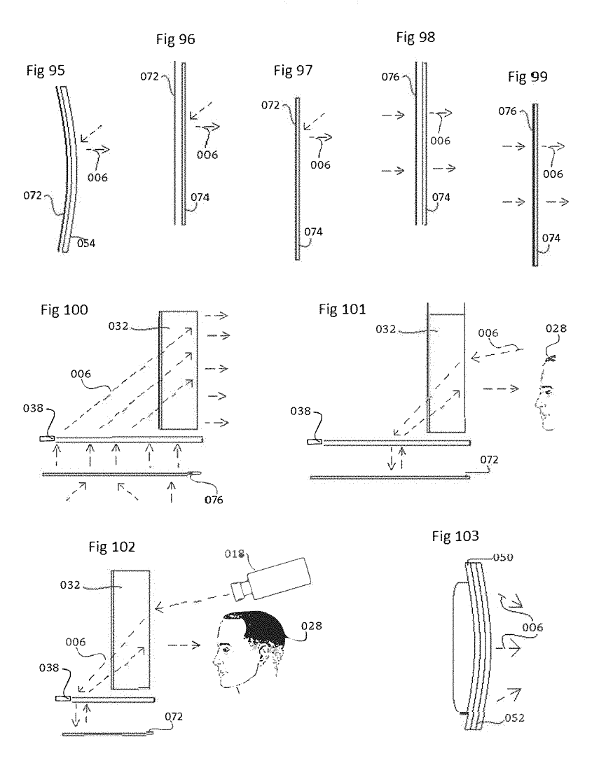

FIGS. 95-103 show examples of an imaging system based on various arrangements of various elements. As shown in the examples in FIGS. 95-103, various elements can be used to provide the imaging system, which includes any one or more of a single lens 054, a rebound material 072, a flexible single lens 074, or a light permeable media 076. FIGS. 95-99 show that two elements are placed to be relative to each other. FIG. 95 illustrate that the single lens 054 and the rebound material 072, which are curved, are placed to be close to each other. FIG. 96 shows that the flexible single lens 074 is placed in parallel with the rebound material 072. FIG. 97 shows an implementation where the rebound material 072 and the flexible single lens 074 are combined or attached to each other. FIG. 98 shows an implementation where the light permeable media 076 and the flexible single lens 074 are place in parallel relative to each other. FIG. 99 shows an implementation where the light permeable media 076 and the flexible single lens 074 are combined or attached to each other. FIGS. 95 and 96 show exemplary light rays 060 that pass through the imaging system. In FIGS. 95-99, any one of single lens 054, a rebound material 072, a flexible single lens 074, or a light permeable media 076 can operate to change the directions of light rays and optically modify some of the light rays to provide holographic-like or 3D effects.

FIGS. 100 and 101 show examples of an imaging system based on a rebound material 072 or a light permeable media 076. In FIGS. 101 and 102, the rebound media 072 and the light permeable media 076 are respectively arranged underneath the disc lens segment 038 placed to be orthogonal to the cylinder lens segment 032. In FIG. 100, portions of light carrying still or moving images of one or more objects or a scene located under the light permeable media 076 proceed from the light permeable media 076 to the disc lens segment 038 and then reach the cylinder lens segment 032. In FIG. 101, portions of light carrying still or moving images of one or more objects or a scene located at or surrounding the outer side surface of the cylinder lens segment 032 proceed from the cylinder lens segment to the disc lens segment 038 and then reaches the rebound media 072. The rebound media 072 operates to redirect some of the light rays towards the disc lens segment 038 and after passing through the disc lens segment 038, some light rays enter the inner side surface of the cylinder lens segment 032. Some of the light rays further proceed to pass through the cylinder lens segment 032 and are viewed by a viewer 028. FIG. 102 shows an example of the recording and viewing operation by using an image projector 018. FIG. 103 shows another example of an imaging system in which a convex curved flat screen 050 is attached to the combined lenses 052.

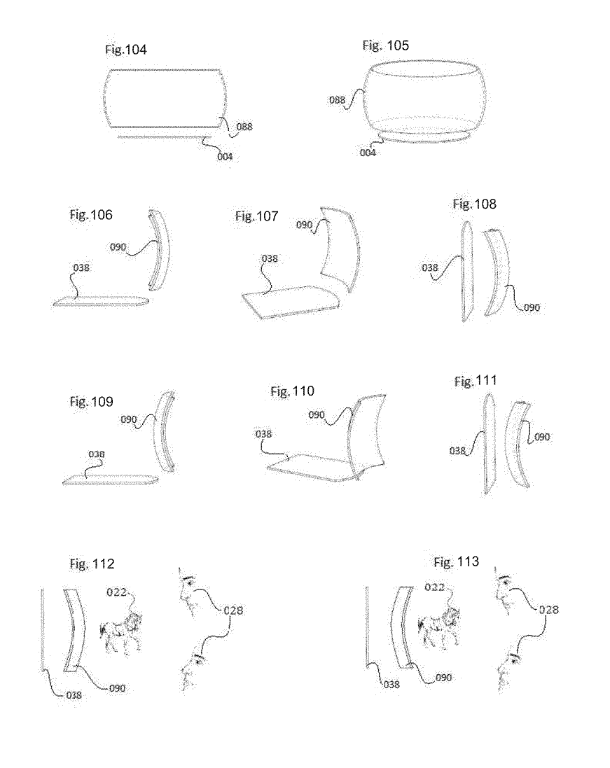

FIGS. 104-113 show various examples of an imaging system based on a fishbowl lens 088 or a fishbowl lens segment 090. FIGS. 104 and 105 show an implementation where the fishbowl lens 088 is placed with the disc lens 004 in the ‘bucket arrangement’. FIGS. 106 and 107 show an arrangement of the disc lens segment 038 and a fishbowl lens segment 090 placed in the right angle arrangement. In FIGS. 106 and 107, the fishbowl lens segment 090 has its concave side toward the area of the disc lens segment 038. In FIG. 106, the multiple fishbowl lens segments 090 are arranged to overlap each other, while in FIG. 107, the single fishbowl lens segment 090 is arranged. FIG. 108 shows that the disc lens segment 038 is placed in parallel in relation to the fishbowl lens segment 090. FIGS. 109, 110 and 111 show another implementation where the fishbowl lens segment 090 has its convex side toward the area of the disc lens segment 038 unlike the examples in FIGS. 106-108. FIGS. 112 and 113 show examples of the viewing operation by using the fishbowl lens segment 090 in which two viewers 028 look into the fishbowl lens segment 090 via its side surface to receive holographic-like apparent image 022 based on the projection of the still or moving images. In FIG. 112, the fishbowl lens segment 090 has its concave side toward the disc lens segment 038. In FIG. 113, the fishbowl lens segment 090 has its convex side toward the disc lens segment 038. The position of the concave side of the fishbowl lens segment 090 relative to the disc lens segment 038 may affect the direction of light rays passing through the fishbowl lens segment 090. Thus, it is possible to provide different holographic-like or 3D effects to a viewer 028 based on the position of the concave side in relation to the disc lens segment 038.

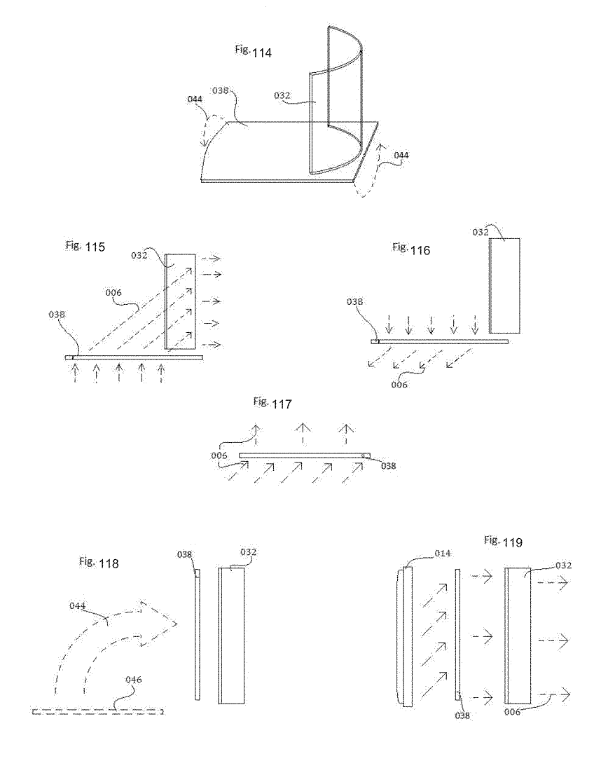

FIGS. 114-118 show examples of an imaging system based on a movement of a disc lens segment 038. FIG. 114 shows the possible movement 044 of the disc lens segment 038 which is originally positioned in the right angle arrangement with the cylinder lens segment 032. As compared to FIG. 66 which also shows the movement of the disc lens segment 038, FIG. 114 shows the different moving direction which makes the disc lens segment 038 reversed about an axis which is perpendicular to the cylinder lens segment 032. As indicated by the arrow(s) showing the movement 044, the disc lens segment is flipped. FIGS. 115 and 116 show examples of the light rays 006 prior to the movement of the disc lens segment 038 and after the movement of the disc lens segment 038, respectively. In some implementations, the exemplary movement of the disc lens segment 038 as shown in FIGS. 114-118 may be combined with the movement as shown in FIG. 66.

FIG. 116 shows the right angle arrangement of the disc lens segment 038 and the cylinder lens segment 032 after the movement of the disc lens segment 038. As shown in FIG. 116, light rays after the movement of the disc lens segment 038 proceed in different directions from those in FIG. 115. Thus, the movement of the disc lens segment 038 causes the directions of the light arrays to change, which provides different holographic-like or 3D effects to a viewer. FIG. 117 shows the disc lens segment 038 alone with some light rays 006. As compared the light rays in FIGS. 115 and 116, the light rays proceed differently in FIG. 117, which indicates that the arrangement of the disc lens segment 038 relative to the cylinder lens segment 032 is related to the directions of the light rays passing through the disc lens segment 038. Thus, the arrangement of the disc lens segment 038 and the cylinder lens segment 032 that are relative to each other can be used to provide various changes on the direction of the light rays passing through the disc lens segment 038 and the cylinder lens segment to provide holographic-like or 3D effects to a viewer. FIGS. 118 and 119 show examples of an arrangement of a disc lens segment 038 and a disc lens segment 032. In FIGS. 118 and 119, the disc lens segment 038 is arranged in parallel with the cylinder lens segment 032 along its longitudinal direction. FIG. 119 shows an imaging recording device, for example, the flat screen display 014, is further arranged to be parallel with the cylinder lens segment 032 and the disc lens segment 038. In FIG. 119, exemplary light rays 006 are illustrated when passing through the disc lens segment 038 and the cylinder lens segment 032. As already discussed, the light rays will enter the inner side surface of the cylinder lens segment 032 and will be optically modified by the cylinder lens segment 032 to change the directions of the light rays.

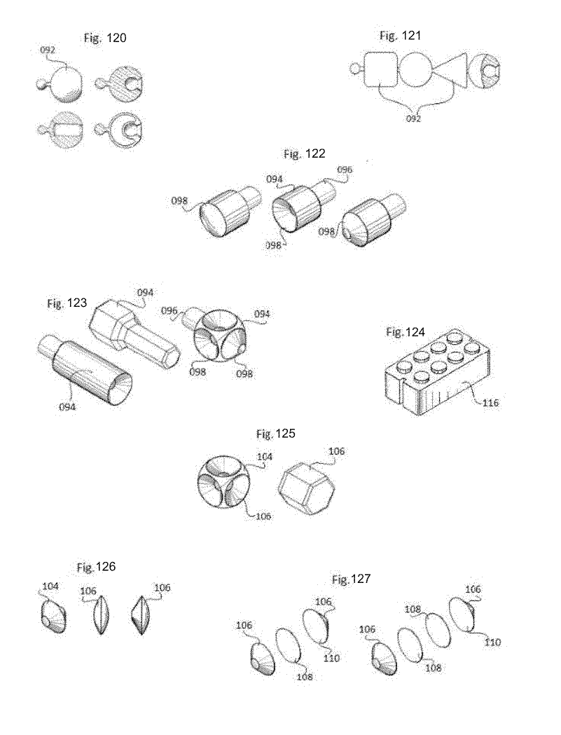

FIGS. 120-127 show exemplary applications employing the disclosed technology. In FIGS. 120-127, one or more portions of the application may be designed to act as a lens or plurality of lenses creating one or a variety of holographic-like images. These items may transmit, reflect, generate, or otherwise interact with light on their surface, internally, or through their internal structures. These items of FIGS. 120-127 may comprise a single or plurality of parts or facets. Some applications may include a single item or a plurality items that can be intended for interactive use. These items of FIGS. 120-127 may be used to show pinpoint, flat image, or holographic-like images. FIG. 120 shows a connecting bead 092 that may connect to other beads. While the connecting bead 092 may be designed to have varying degrees of filling inside the connecting bead, the connecting bead 092 may be mostly filled, which could be considered as a ‘solid’ bead, or of varying designs of partially filled, or mostly hollow. FIG. 121 shows a chain of several shapes of the connecting bead 092. FIG. 122 shows a series of pegs including a peg body 094, peg stem 096, and a variety of peg face(s) 098. Any part of the pegs, for example, external or internal of the pegs, may act as a lens. The pegs shown in FIG. 122 could be used with a toy such as the Lite Brite sets. FIG. 123 shows a variety of pegs and the peg face(s) 098. FIG. 124 shows a block 116. The blocks 110 of FIG. 124 may have one or a plurality of holographic-like effects on its internal or external side(s). FIG. 125 shows a variety of bead(s) 104 with a variety of bead face(s) 106. FIG. 126 shows bead(s) 104 with a bead face(s) 106. In some implementations, each bead may have different designs with a different bead face 106. FIG. 127 shows an expanded view of the beads with bead faces. In FIG. 127, the bead may be constructed to be solid, or have a plurality of internal surfaces, or have one or a plurality of an insert(s) or sequin(s) 108. An insert or sequin 108 may also be used as a sequin, or a jewel, or other decorative or functional means such as a button, snap, clasp, or attachment, or cover for such.

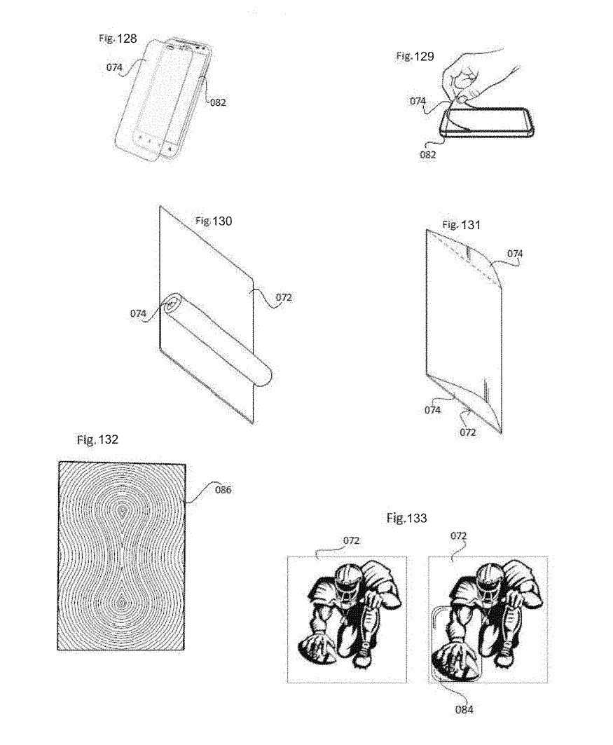

FIGS. 128-133 further show exemplary applications employing the disclosed technology. FIG. 128 shows the single lens 074 used with a mobile screen 082 such as a smart phone or tablet. FIG. 129 shows the flexible single lens 074 used with the mobile screen 082 such as a smart phone or tablet. FIG. 130 shows the flexible single lens 074 being used with print media such as the rebound material 072. FIG. 131 shows an implementation where the additional flexible single lens 074 is added to the implementation of FIG. 130 to give additional visual effects. FIG. 132 shows an exemplary variable concentration lens 086 that may be used to provide the holographic effects. The holographic lenses may be made in a variety of designs. For example, if a Fresnel lens or a similar lens to the Fresnel lens is used, the overall shape of grooves could make an oval pattern, a clover leaf pattern, or a FIG. 8 pattern as shown in FIG. 161. The shape of the sides of the individual grooves could also be varied, within the same design or from design to design. A specific lens design may be used for television and another specific design may be used for video gaming machines such as slots or poker. In this case, viewing television on a gaming design may give distorted images. FIG. 133 shows an poster including the rebound material 072 with the variable concentration lens 086 which is designed with a pop area 084 that may appear to change as the viewer walks fast or changes their viewing angle. In this example, by configuring the pop area 084 with the variable concentration lens 086, it is possible to give the effects that the football and the player's arm are moving, or at least simply being seen as having greater depth than the rest of the poster. An advertising poster using a cloverleaf or multiple focus variable concentration lenses 086 can be configured to have one or more ‘pop out’ sections as a viewer walks fast. As the viewer walks, different phrases could be focused, for example, first ‘On Sale!,’ then ‘Half off!,’ and ‘Limited Time!.’

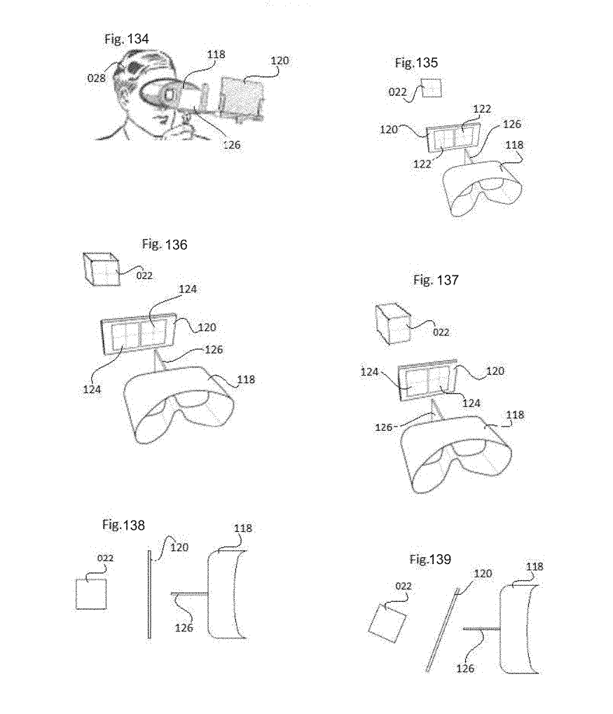

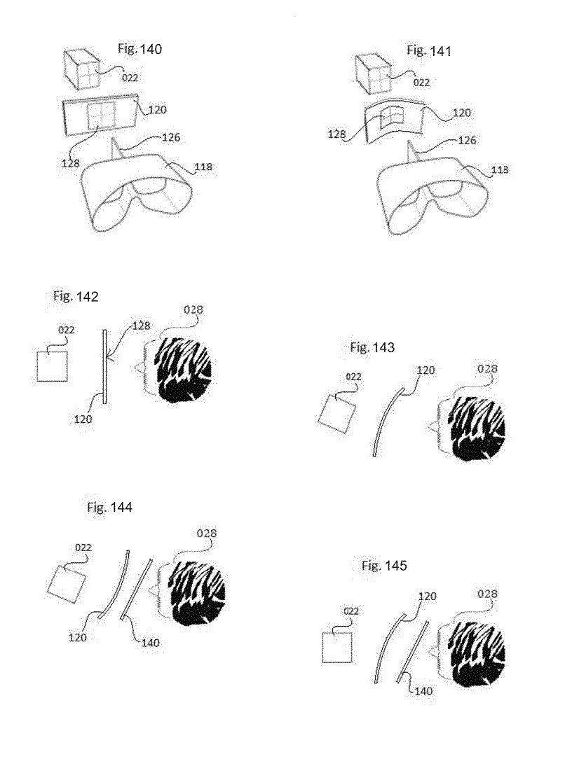

FIGS. 134-141 further show exemplary implementations based on a stereoscope which is used to view an apparent image provided based on one implementation of the disclosed technology. FIG. 134 shows the viewer 028 using a stereoscope including a stereo viewer 118, a divider 126 and an image holder 120 to view an apparent image 022. FIGS. 135 and 136 show examples where an apparent image 22 is perceived using different images 120 and 122 or same images 124. FIG. 135 shows the example where the apparent image 022 is perceived when both of differing images 120 and 122 are in proper placement on the image holder 120. The differing images 120 and 122 are two different but similar images, showing the same scene but from slightly differing angles. The two different images are used to create only the perception of depth. Referring to FIG. 135, the viewer 028 can perceive the object 22 which appears in response to the placement of the different images 120 and 122. FIG. 136 shows an implementation where identical image(s) 124 is placed on the image holder 120. These identical image(s) 124 may be recorded according to an implementation of the disclosed technology. The images are visually identical to the viewer. When viewed through the stereoscope, these identical image(s) 124 may be perceived by the viewer as holographic in addition to 3D effects. That is, the viewer 028 can perceive the object 22 with holographic and 3D effects. FIG. 137 shows that the image holder 120 is moved such that the divider 126 is located in a different position than that of FIGS. 135 and 136. By moving the image holder 120 at a slight angle relative to the viewer, the center of the identical image(s) 124 can be positioned at different distances from each eye of the viewer. FIGS. 138 and 139 show top views of FIGS. 136 and 137, respectively. Moving the image holder 120 with the identical image(s) 124 may cause the viewer to perceive the apparent image 022 at an angle different from the previous angle before the movement. FIG. 140 shows the stereoscope with a single image 128 placed on the image holder 120. This also can allow the viewer 028 to perceive the apparent image 022 as holographic. FIG. 141 shows that the image holder 120 and the single image 128 are curved. FIGS. 142-145 show other implementations where a viewer can view an apparent image without a stereoscope. In FIGS. 142 and 143, a viewer 028 is positioned to look the image 120 which is the single image 128 and provided by some implementations of the disclosed technology. In FIGS. 144 and 145, a lens 140 is positioned between the image 120 and the viewer 028 to facilitate the viewing operation. When the image 120 is curved as shown in FIG. 141, the convex surface of the lens is arranged toward the viewer and the object 22 in FIGS. 144 and 145, respectively.

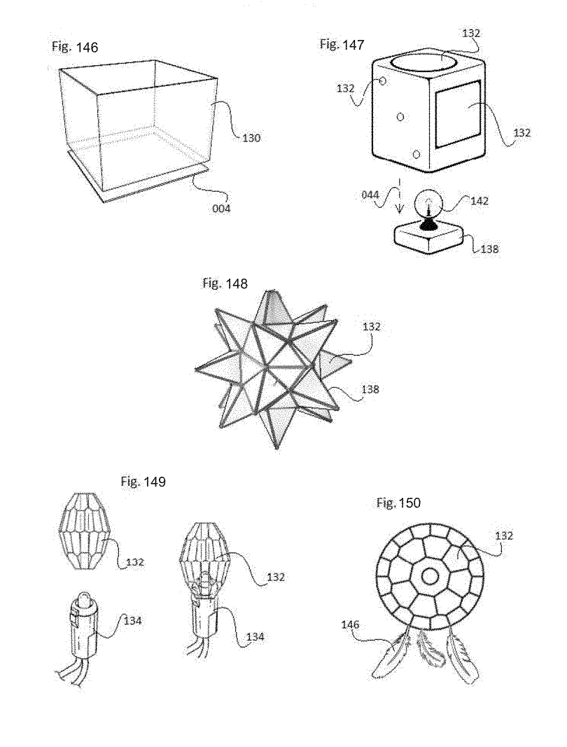

FIGS. 146-150 show exemplary applications of the disclosed technology. FIG. 146 shows a cube lens 130 arranged with a disc lens 004. This may be used to mimic a terrarium or aquarium, with video showing pixies, sprites, or dragons coming and going through the ‘glass walls’. FIG. 147 shows a plurality of lenses 132 having different lens types, with an origin 142 positioned on the attachment 138. The origin 142 may be a simple light source, or a part or independent holographic system. FIG. 148 shows a sunburst or starburst design that could be lighted or a passive ornament. The sunburst or starburst design is configured to include the lens 132 combined with the attachment 138. FIG. 149 shows a Christmas tree or other decorative light including the lens 132 and the source of image or light 134. FIG. 150 shows a ‘dream catcher’ which may have one or a plurality of lenses 132 with additional decorations 146.

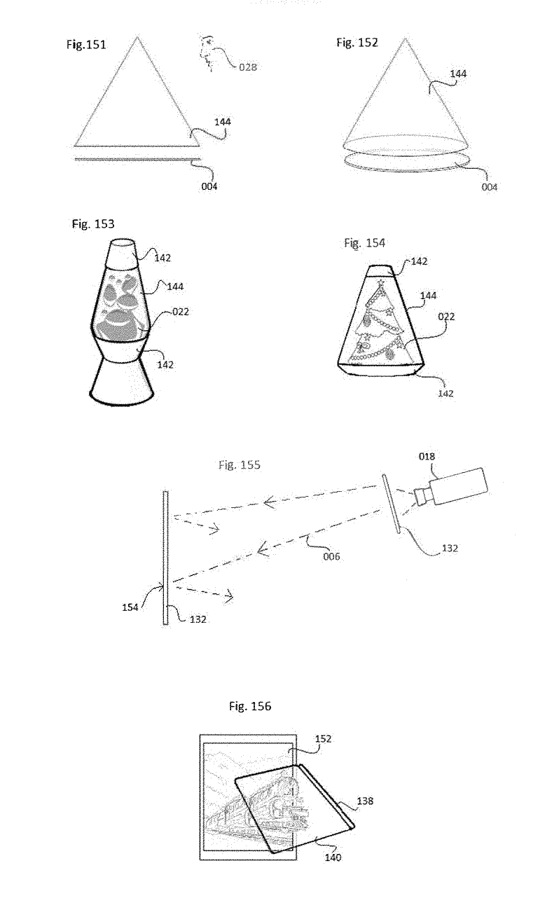

FIGS. 151-154 show exemplary implementations of the disclosed technology including a cone lens 144 arranged with a disc lens 004. FIGS. 153 and 154 show exemplary applications employing the cone lens 144. FIG. 153 shows a lava lamp type display and FIG. 154 shows a holiday display. FIG. 155 shows a theater arrangement in which the disclosed technology is applied. In FIG. 155, lenses 132 are arranged with the image projector 018 and the reflective media to provide holographic effects.

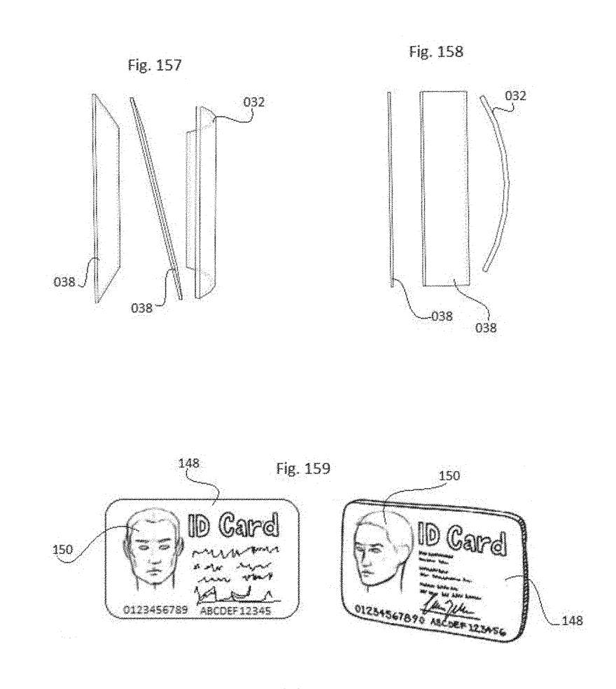

FIGS. 156-158 show implementations of the disclosed technology including a holographic page reader. FIG. 156 shows a holographic page reader, which may use a lens which is specific to books. The lens 140 is provided with the attachment 138. By positioning the lens 140 over an image in the media 152, the viewer can be provided with holographic effects. By using the holographic page reader, a reader can more enjoy a book by creating different holographic effects. FIGS. 157 and 158 show exemplary views in which a third lens 038 is positioned between the cylinder lens segment 032 and the disc lens segment 038 that are positioned in parallel to each other. In FIG. 157, the third lens 038 is tilted in relation to the cylinder lens segment 032 and the disc lens segment 038 to provide different holographic effects by changing the directions of light rays passing through the third lens.

FIG. 159 shows another implementation in which the disclosed technology is applied to an ID card, for example, a driver's license, to provide a holographic driver's license. The holographic driver's license may include a holographic image 150 including intentionally intended distortions. The intended distortions can be provided by various methods as discussed above, for example, by using the same or similar curved lenses in both the recording and the rendering operations. The distortion included in the holographic image 150 can be removed by using a specific lens only which is provided to authorized users only. The specific lens to undo the distortions may be the same or similar curved lens which was used in the recording phase and the rendering phase. By constructing the ID card using the holographic-like image, even if the driver's license is lost, it is possible to prevent non-authorized persons from using the ID card. Thus, only authorized persons can use the ID card and it is possible to increases the security level.

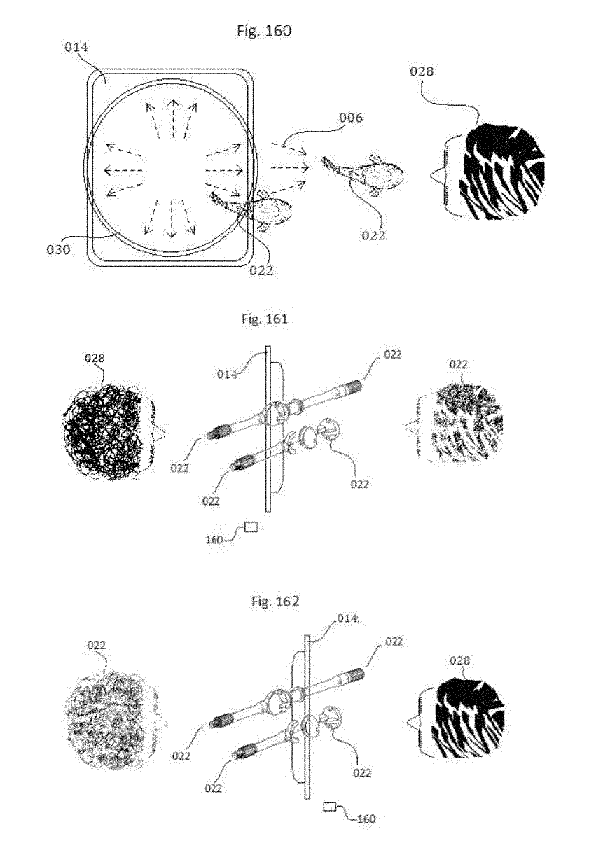

FIG. 160 shows an implementation where a viewer can view an apparent image provided based on one implementation of the disclosed technology. Referring to FIG. 160, the exemplary imaging system includes the recording device 014 and the lens 030. Ambient or generated light is reflected from the object, some of the light passes through the lens 030, and is received by the recording device 014. The recording device 014 records one or more images of the object as seen through the lens 030. When the viewer is looking toward the lens, the imaging system allows the viewer to perceive the apparent image 022 which is positioned outside the lens 030.

Some implementations of the disclosed technology provide a CAD holographic display. For example, the fictional CAD holographic display as shown in the ‘Iron Man’ series of movies is embodied. In these exemplary scenes, the actor appears to view and manipulate holographic images. In some implementations, each viewer would appear to see their co-worker with the CAD holographic-like image between them. Each viewer could view and affect the CAD holographic-like image, while appearing face to face with another person. A user interface would be needed, such as conventional hardware, or an ‘air mouse’ motion sensing system.

FIGS. 161 and 162 show an exemplary implementation of a holographic-like display based on the disclosed technology. FIG. 161 shows a view where a first viewer 028 looks at a holographic-like display 162 and is provided with the perceived images 022 while being observed by a holographic-like camera 160. FIG. 162 shows a view where the second viewer 029 looks at the holographic-like display 162 and is provided with the perceived image 022 including the first viewer 022 while being observed by the holographic-like camera 160. Using the holographic-like display in FIGS. 161 and 162, the first viewer in a first location can view the perceived image 022 including the second viewer in a second location. In this way, viewers can see each other even through the holographic-like display. The exemplary system as shown in FIGS. 161 and 162 would be modified in various manners, for example, to include a single display 162 only or multiple devices working together. In some implementations, the holographic-like camera 160 would not be needed. One device could be used for instruction on many other devices. Three or more devices and workers could operate as a group working on a project.

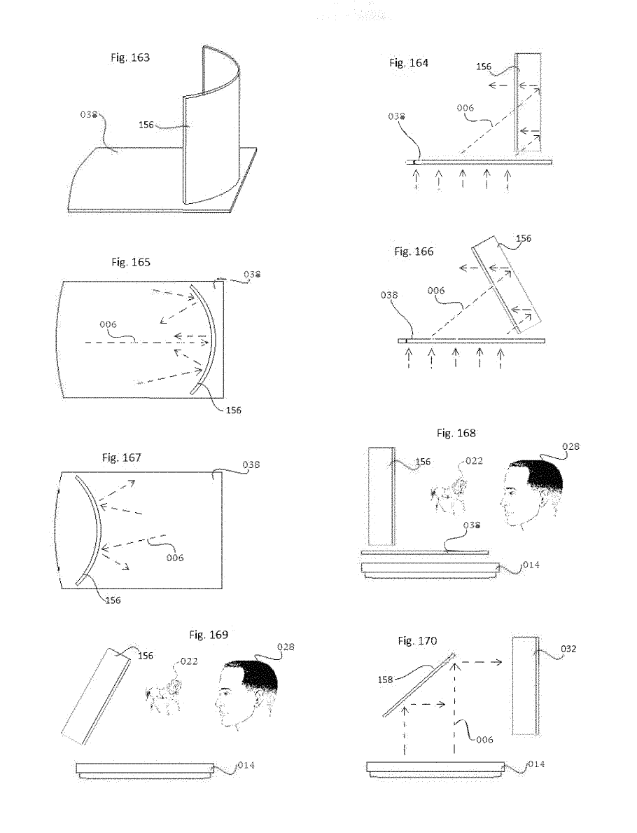

FIGS. 163-170 show various embodiments of the disclosed technology using a mirror or mirrors, or a combination of one or more mirrors or lens. FIG. 163 shows a perspective view of a curved reflector 156 with a disc lens segment 038. FIGS. 164 and 165 show a side view and a top view of the curved reflector 156 with the disc lens segment 038. In the examples as shown in FIGS. 163-165, the curved reflector 156 and the dis lens segment 038 are arranged to form the right angle. Referring to FIGS. 164 and 165, the light rays 006 change their directions while being affected by the curved reflector 156. FIGS. 166 and 167 show exemplary modifications of the arrangement of a curved reflector 156 and a disc lens segment 038. FIG. 166 shows another side view of a curved reflector 156 that is slanted with respect to a disc lens segment 038. In FIG. 166, the curved reflector 156 and the disc lens segment 038 are not perpendicular to each other. FIG. 167 shows a top view of a curved reflector 156 provided in another arrangement with a disc lens segment 038. FIGS. 166 and 167 show the light rays whose directions are changed after arriving at the curved reflector 156. FIGS. 168 and 169 respectively shows an example of the viewing operation by using the curved reflector 156 and the disc lens segment that are arranged as shown in FIGS. 164 and 166. The viewing operation proceeds using the curved reflector for image rending in which an imaging projection device, e.g., a flat screen display 014, is placed underneath the disc lens segment 038 to display recorded still or moving images, e.g., at a flat screen such as an LCD or OLED display screen. There can be more than one viewers 028 to view the same rendered still or moving images at different locations around the curved reflector 156 or a viewer 028 may move around the curved reflector 156 to view the rendered still or moving images from different viewing locations. In this viewing operation, the modified light rays emerging on the outer side of the curved reflector 156 can carry still or moving images of one or more objects. Due to the relationship of the recording and viewing operations, an object or a scene appears to the viewer 028 as a holographic like or in a 3D perception.

FIGS. 163-169 show a curved reflector as the exemplary image rendering element but the reflector can have various shapes including curved or non-curved ones. FIG. 170 shows where a flat reflector 158 instead of a curved reflector 156 is arranged in relative to a flat screen display 014 and a cylinder lens segment 032. In FIG. 170, light rays from the flat screen display 014 change their direction at the surface of the flat reflector 180 and proceeds to the cylinder lens segment 032. The flat screen display 014 is placed at one side of the flat reflector 158 to record an image of an object or a scene. In the example as shown in FIG. 170, the flat reflector 158 is located at a slant angle with respect to a line parallel to the surface of the flat reflector 158 and the cylinder lens segment 032 is located perpendicular to the parallel line to the surface of the flat reflector 158. FIG. 170 also shows the exemplary light rays 006 in their respective directions when passing through the flat reflector 158. Under this recording operation, the images of one or more objects or a scene are received by the flat reflector 158 from the flat screen display 014 and then captured via the cylinder lens segment 032. The cylinder lens segment 032 operates to optically modify the recorded images through the flat reflector 158.

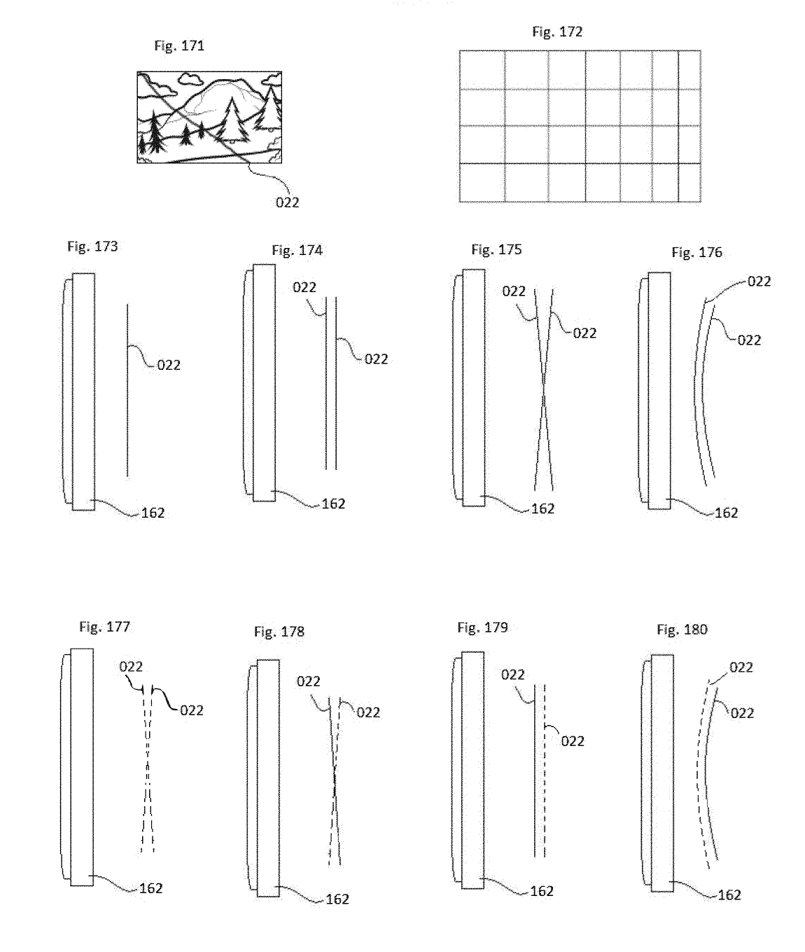

FIGS. 171-180 show various examples of the disclosed technology to display an apparent image as flat, or two-dimensional, or others. The examples of the disclosed technology allow the added apparent perception of depth to flat images that may lack an apparent perception of depth. FIG. 171 shows a two-dimensional drawing, which can appear as the apparent image 022 in FIGS. 173-180. FIG. 172 shows a distortion of a grid of squares. An image such as a two-dimensional photograph may be distorted as the grid shows, either stretched or compressed in a gradient manner. An existing flat screen image may be altered to be perceived as having added depth by distorting a single image in this manner in one direction, and distorting a similar image in another direction. These images may then be shown one at a time, one after the other, in succession similar to a television or movie theater, for example, images may be shown and replaced rapidly enough that the images may seem to be somewhat continuous. These altered images, with differing distortions, may be shown in such a manner, and this may give a viewer the illusion of perceived depth.

Some implementations of the disclosed technology may show an image that may be perceived as flat. This image may be shown so as to be perceived similar to the flat image shown in FIG. 171. FIG. 173 shows a holographic-like display 162 with an apparent image 022 as a flat image. FIGS. 174-180 show a holographic-like display 162 with apparent images 022 that are flat. The apparent images 022 in FIGS. 174-180 may be of one image or more than one images shown simultaneously, or in the manner of one without the other, or in an overlapping sequence in which some or all of one or more images are shown somewhat concurrently. In FIG. 174, the apparent images are shown in parallel to each other and to the holographic-like display 162. In FIG. 175, the apparent images are shown as not parallel to each other and to the holographic-like display. In FIG. 176, the images may be shown as different from a plane, such as arched, one or more curves, curved, or in many topological shapes. In FIGS. 177-180, at least one of the images may be shown partially with another whole image, or with another partial image. Although the examples as shown in FIGS. 173-180 show apparent images with possible effects that may increase the perceived depth in a horizontal direction to the device 162, the disclosed technology is not limited thereto and can be utilized in a manner other than horizontal. For example, it is also possible to allow the perception of added depth vertically, or other than vertical applications.

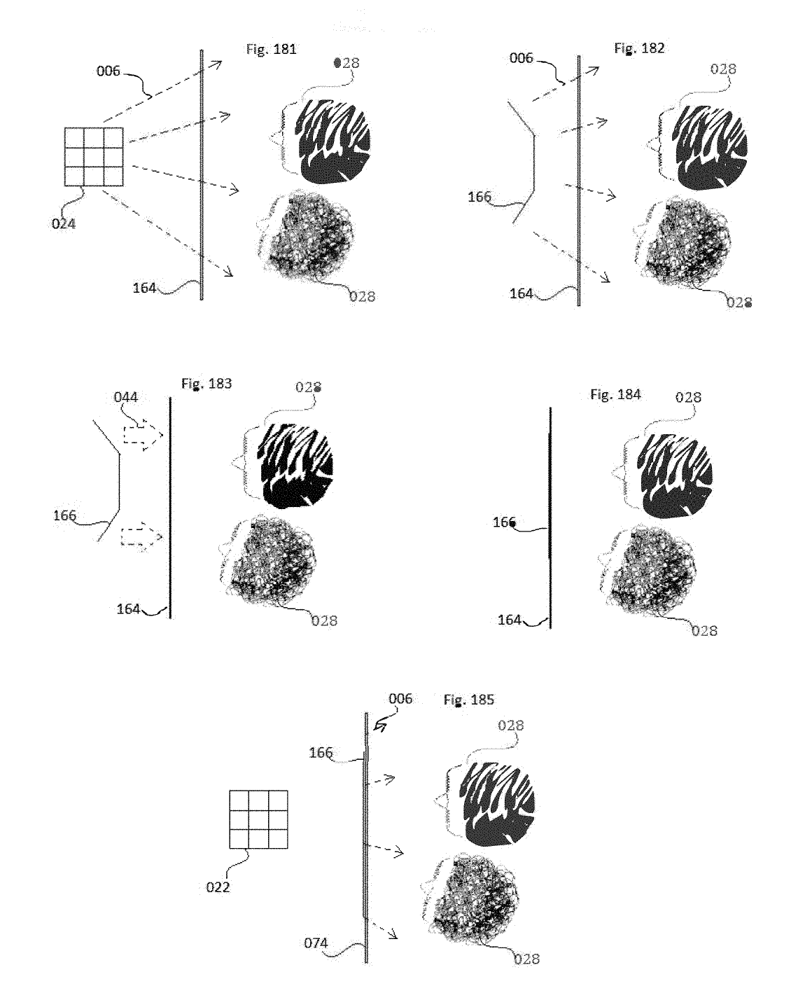

FIGS. 181 to 185 illustrate some implementations of the disclosed technology to allow a viewer to perceive an apparent depth of an image. The perceived depth may have holographic-like qualities as well. For example, when viewed from various positions having different angels of view, the image will not only be perceived to have apparent depth, but that the image can be perceived from various positions. FIG. 181 shows a view of some light rays 006 of an object 024 which may pass through a plane 164 and be viewed by a viewer 028. The plane 164 may include a glass window. The plane 164 is illustrated as an example and can be implemented using a mathematical application. The directions of the light rays 006 from the object 024 may vary and the light rays 006 at varied angles allow the viewer 028 to use a conventional binocular to perceive the object 024 as a three-dimensional object. FIG. 182 shows a surface structure 166 which has been removed from the object 024. FIG. 183 shows the surface structure 166 being moved toward the plane 164 in the direction indicated with arrow(s) 044. FIG. 184 shows the surface structure 166 in the area of the plane 164. In this case, the image may not be perceived by the viewer 028 as similarly to the originally viewed with the object 024. The surface structure 166 may have been distorted from its original shape and orientation by the movement to the plane 164. FIG. 185 shows the surface structure 166 is located near a single lens 074. The single lens 074 may add parallax to some light rays 006 coming from the surface structure 166. The combination of this possibly distorted the surface structure 166 and the single lens 074 that may give parallax to some light rays 006 may allow the viewer(s) 028 using their common binocular vision to perceive added depth in the image with holographic-like properties, which may allow them to perceive the apparent object 022.

The disclosed technology may be used in many situations where an improved visualization of images may be of benefit. Examples of an area to which the disclosed technology is applied include a CAD program for engineers or architects, representing radar or other imaging system information for geological structures, topological maps, medical imaging, modeling mathematical or theoretical structures for academic pursuits. According to the disclosed technology, greater accuracy in sports viewing and replay can be achieved and greater realism and immersion at theaters and home viewing can be obtained. Advertising may be performed in a manner that attracts more attentions.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed are techniques and structures as described and shown, including:

1. An imaging apparatus providing a holographic-like image, the imaging apparatus including:
a lens having a lens axis and operating to receive light rays reflecting from an object and change directions of the light rays passing through the lens, the object located on or around the lens axis; and
a recording device arranged to receive the light rays from the lens and records an image of an object, the image of the object having distortion information that provide holographic effects.

2. The imaging apparatus of claim 1, wherein the lens operates as a Fresnel lens magnifier.

3. The imaging apparatus of claim 1, wherein the lens includes a disc lens or a cylinder lens.

4. The imaging apparatus of claim 1, wherein the image of the object includes a single flat, two-dimensional image.

5. The imaging apparatus of claim 1, wherein the recording device includes a camera.

6. The imaging apparatus of claim 1, wherein the recording device is centered on the lens axis.

7. An imaging apparatus providing a holographic-like image, the imaging apparatus including:
a first lens having a lens axis and operating to reflect a light originating from an object;
a recording device centered on the lens axis and operates to receive the reflected light from the first lens and records an image of the object; and
a second lens arranged in relation to the first lens and operating to receive the image from the recording device through the first lens and operates to provide a holographic-like perception to a viewer.

8. The imaging apparatus of claim 7, wherein the second lens is arranged to form a bucket shape with the first lens such that the second lens has an end near which the first lens is centered.

9. The imaging apparatus of claim 7, wherein the first lens and the second lens are fully enclosed.

10. The imaging apparatus of claim 7, wherein at least one of the first lens or the second lens has a shape that forms a portion of an enclosure.

11. The imaging apparatus of claim 10, wherein the first lens is rotatable in a plane where the first lens is arranged.

12. The imaging apparatus of claim 7, wherein the second lens is curved.

13. The imaging apparatus of claim 10, wherein the first lens is movable between two planes that are orthogonal to each other such that the first lens is located parallel to second lens along the lens axis.

14. The imaging apparatus of claim 7, wherein the first lens includes a disc lens and the second lens includes at least one of a cylinder lens, a cube lens, or a cone lens.

15. The imaging apparatus of claim 7, wherein the first lens and the second lens are combined to provide a single unit having optical properties of the first lens and the second lens.

16. The imaging apparatus of claim 7, wherein the first lens and the second lens include portions of a Fresnel lens.

17. An imaging apparatus viewing a holographic-like image, the imaging apparatus including:
an object;
an image holder positioned to face the object and holding an image of the object having intentionally intended distortions, wherein the image is obtained by passing lights reflecting from the object through a lens having a lens center in a direction radially outward from the lens center and at an angle with regard to the lens; and
a stereoscope arranged to be movable with regard to the image holder and operates to allow a viewer to view the object through the image holder.

18. The imaging apparatus of claim 17, wherein the image holder holds an additional image that is different from or identical to the image.

19. The imaging apparatus of claim 17, wherein the image holder is positioned to be movable with regard to the stereoscope, the movement of the image holder changing viewpoints of the object.

20. The imaging apparatus of claim 17, wherein the image holder is flat or curved.

21. A method for rendering an image to a viewer with a holographic like or 3-dimensional perception, comprising:
recording an image from light rays received from a curved recording lens that includes a cylindrical shape at a location below the curved recording lens at or near a geometrical axis of the cylindrical shape to receive light rays from one or more objects or a scene located outside the curved recording lens; and
displaying the recorded image at a surface that is located below a curved image-rendering lens that is similar or identical to the curved recording lens used in recording the image to direct light from the displayed image to inner space of the curved image-rendering lens and to be optically modified to produce emerging light rays to be perceived by one or more viewers looking at the curved image-rendering lens as being from one or more objects or a scene located in or outside the inner space within the cylindrical shape of the curved image-rendering lens.

22. The method as in claim 21, further comprising:
placing a second recording lens between the curved recording lens and the location for recording the image to further optically modify the light rays from the curved recording lens in recording the image; and
placing a second image-rendering lens located between the curved image-rendering lens and the surface displaying the recorded image to optically modify the light rays before reaching the curved image-rendering lens for viewing.

23. An imaging display device for rendering an image to a viewer with a holographic like or 3-dimensional perception, comprising:
a curved image-rendering lens that includes a cylindrical shape to support a curved side surface and an inner space within the curved side surface; and
an image displaying device placed below the curved image-rendering lens to display still or moving images that are recorded via a curved recording lens that is similar or identical to the curved image-rendering lens to direct light from the displayed image to inner space of the curved image-rendering lens and to be optically modified to produce emerging light rays outside the cylindrical shape to be viewed by a viewer.

24. The device as in claim 23, further comprising:
a second recording lens between the curved recording lens and the location for recording the image to further optically modify the light rays from the curved recording lens in recording the image; and
a second image-rendering lens located between the curved image-rendering lens and the image displaying device displaying the recorded image to optically modify the light rays before reaching the curved image-rendering lens for viewing.
